(19) United States
(12) Patent Application Publication
(10) Pub. No.: US 2015/0120376 A1
(43) Pub. Date: Apr. 30, 2015

(54) DATA PROCESSING DEVICE AND METHOD

(71) Applicant: FUJITSU LIMITED, Kawasaki-shi (JP)

(72) Inventors: Takahiro Inagaki, Ama (JP); Kiyoshi Kouge, Kuwana (JP)

(73) Assignee: FUJITSU LIMITED, Kawasaki-shi (JP)

(21) Appl. No.: 14/587,393

(22) Filed: Dec. 31, 2014

Related U.S. Application Data
(63) Continuation of application No. PCT/JP2012/067232, filed on Jul. 5, 2012.

(51) Int. Cl. G06Q 10/06

(52) U.S. Cl. CPC G06Q 10/06316
USPC 705/7.26

(57) ABSTRACT

A data processing device includes a processor that executes a process. The process includes: analyzing job flow information based on information indicating a processing sequence and processing content, and generating analysis information including information indicating jobs processable in parallel, and information indicating a processing sequence of the jobs processable in parallel; and associating the job flow information that was a target of analysis with the analysis information obtained from the job flow information that was the target of analysis and registering the associated information in a memory.

### CROSS-REFERENCE TO RELATED APPLICATION

This application is a continuation application of International Application No. PCT/JP2012/067232, filed Jul. 5, 2012, the disclosure of which is incorporated herein by reference in its entirety.

### FIELD

The embodiments discussed herein are related to a data processing device, a data processing method, and a recording medium storing a data processing program.

### BACKGROUND

Business is typically advanced by using business systems that include computers. For example, a processing device is known in which, for single jobs of processing in which freely selected work is executed on input data to obtain output data, processing is performed on each respective job according to job flow information indicating relationships between a series of plural jobs.

In processing devices for processing each job according to the job flow information, there is demand for provision of a processing capability enabling the processing load to be handled when processing each job indicated by the job flow information. For example, the processing load in a processing device when processing a job is higher for processing on large volumes of input data than for processing on small volumes of input data.

Moreover, the processing load on a processing device changes hourly according to the business operating on the processing device. Thus, sometimes the processing load on a processing device changes greatly. It is preferable to reduce processing loads on processing devices in order to use processing devices efficiently.

Technology is known that generates parallel execution-type job control language in order to reduce the processing load of a processing device. Technology that generates parallel execution-type job control language, generates the parallel execution-type job control language from execution history information of jobs and job steps, data access information by job step, or inter-job step correlation relationships. In technology that generates the parallel execution-type job control language, jobs are automatically executed in parallel using the generated parallel execution-type job control language.

Moreover, technology is known in which task execution costs are derived, and tasks are allocated to a general-purpose processor with low execution cost, or to an accelerator, as appropriate. On multi-processor systems, technology that allocates tasks to general-purpose processors or accelerators, extracts parallelism based on control dependencies and data dependencies between plural tasks. A task execution cost is derived by calculating execution cost from the extracted parallelism, and tasks are allocated to a general-purpose processor with low execution cost, or to an accelerator. Specifically, when there is a mixed presence of general-purpose processors, and accelerator processors, a processor is sought with low execution cost for each task seeking execution, and the task is allocated to the processor with low execution cost. Moreover, in technology for allocating tasks to processors with low execution costs, in cases in which determination is made that the task is a program processable in parallel within a system, and that the execution cost of general-purpose processors is low, the task can be distributed across plural general-purpose processors.

### RELATED PATENT DOCUMENTS

Japanese Laid-Open Patent Publication No. H10-214195
Japanese Laid-Open Patent Publication No. 2007-328415

### SUMMARY

According to an aspect of the embodiments, A data processing device comprising: a memory configured to store job flow information that includes a processing sequence information indicating a processing sequence of a plurality of jobs and a processing content information indicating respective processing content of the plurality of jobs; and a processor configured to execute a process, the process comprising: generating an analysis information including parallel processing information and parallel processing sequence information by analyzing the job flow information based on the processing sequence information and the processing content information, the parallel processing information indicating jobs processable in parallel, and the parallel processing sequence information indicating a processing sequence of the jobs processable in parallel; and associating the analysis information with corresponding part of the job flow information and storing the associated information in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic block diagram illustrating a data processing system according to a first exemplary embodiment.

FIG. 2 is a schematic block diagram illustrating an example of a data processing device;

FIG. 3 is a block diagram illustrating an example of information stored in a storage section of an on-premises system;

FIG. 4 is an illustrative diagram illustrating an example of a job flow management table;

FIG. 5 is an illustrative diagram illustrating an example of a job management table;

FIG. 6 is an illustrative diagram illustrating an example of a file management table;

FIG. 7 is a block diagram illustrating an example of a structure of job flow information;

FIG. 8 is an explanatory diagram illustrating processing that specifies job flow information;

FIG. 9 is a flowchart illustrating a flow of an analysis process;

FIG. 10 is an explanatory diagram of a structure analysis of job flow information;

FIG. 11 is a flowchart illustrating an example of a flow of analysis processing;

FIG. 12 is a flowchart illustrating a detailed example of a flow of analysis processing;

FIG. 13 is a flowchart illustrating a flow of processing of an execution process;

FIG. 14 is a flowchart illustrating a flow of execution processing according to job flow information;

FIG. 15 is a block diagram illustrating an example of a first modified example for a structure of job flow information;

FIG. 16 is a block diagram illustrating a second modified example for a structure of job flow information;

FIG. 17 is a flowchart illustrating an example of a data processing program according to a fourth exemplary embodiment;

FIG. 18 is a schematic block diagram illustrating a data processing system according to a fifth exemplary embodiment;

FIG. 19 is an illustrative diagram illustrating an example of information stored in a storage section according to a fifth exemplary embodiment;

FIG. 20 is a flowchart illustrating a data processing program according to the fifth exemplary embodiment;

FIG. 21 is a flowchart illustrating a flow of execution processing according to job flow information;

FIG. 22 is a flowchart illustrating an example of setting processing for an individual executable-in-cloud flag; and

FIG. 23 is a flowchart illustrating an example of a flow of individual execution processing.

### DESCRIPTION OF EMBODIMENTS

Detailed explanation is given below with reference to the drawings regarding examples of embodiments of technology disclosed herein.

### First Exemplary Embodiment

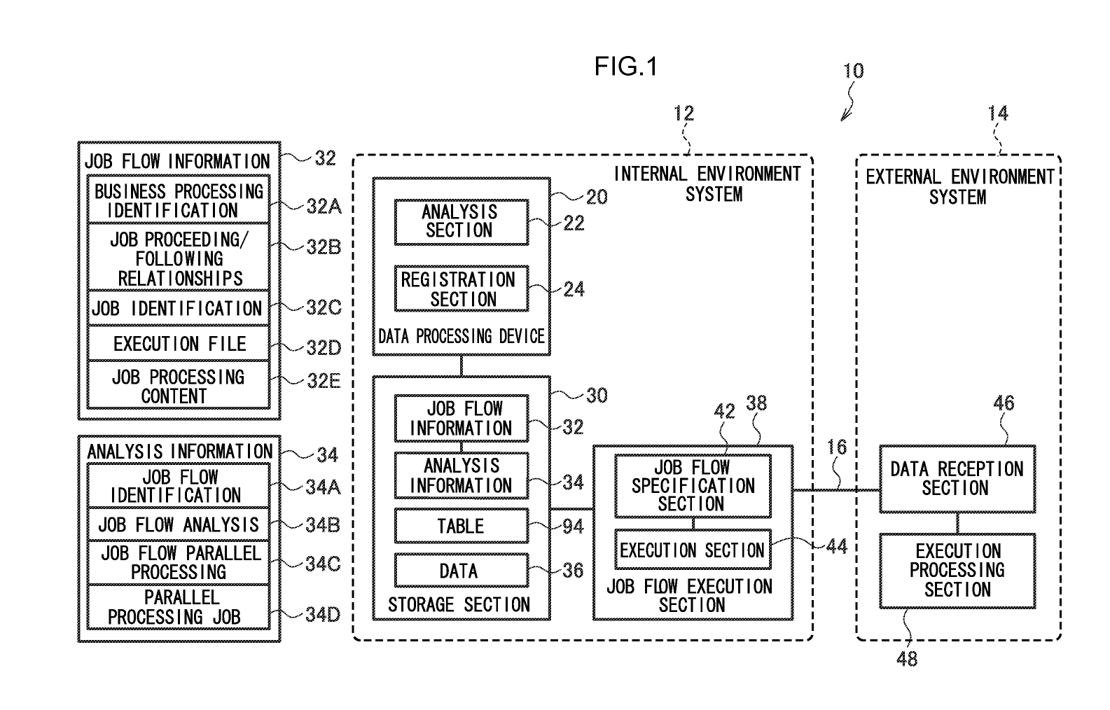

FIG. 1 illustrates a data processing system 10 according a first exemplary embodiment. The data processing system 10 is a processing device that executes business processing using a computer, based on job flow information indicating relationships in a series of plural associated jobs, for plural jobs in which processing is executed with respect to input data. The data processing system 10 includes an internal environment system 12, and an external environment system 14. The internal environment system 12 and the external environment system 14 are connected through a communications line 16. The communications line 16 encompasses communications network lines, such as telephone lines or the internet. The internal environment system 12 includes a data processing device 20, a storage section 30, and a job flow execution section 38. The data processing device 20 includes an analysis section 22, and a registration section 24. The storage section 30 is stored with job flow information 32, analysis information 34, tables 94, and 36 that is the target of processing by the job flow information 32. The job flow execution section 38 includes a job flow specification section 42, and an execution section 44 that executes the associated series of plural jobs indicated by job flow information specified by the job flow specification section 42. The external environment system 14 includes a data exchange section 46, and an execution processing section 48.

The first exemplary embodiment executes business processing using a computer, based on the job flow information 32. The job flow information 32 indicates relationships between plural jobs that perform a processing series on data. Specially, the job flow information 32 includes information indicating the processing sequence of the respective plural jobs that perform a processing series on data, and information indicating the processing content of the respective plural jobs. For example, for business processing in which a series of plural jobs are executed using a computer, the job flow information 32 includes information 32A that identifies the business processing, and information 32B that indicates proceeding/following relationships in the processing sequence of the series of plural jobs. Moreover, the job flow information 32 may include information 32C identifying each job, information 32D indicating an execution file for execution of processing for each of the jobs, and information 32E indicating processing content for each of the jobs. Using the job flow information 32 thereby enables a job sequence and the jobs to be processed with the job flow information 32 to be identified from the information 32B that indicates the proceeding/following relationships in the series of plural jobs, and the information 32C that identifies each job. Using the information 32D indicating the execution files, the execution file to be processed by the computer can be identified for each job to be sequentially processed according to the job flow information 32. Jobs that are the target of sequential processing according to the job flow information 32 can be identified using the information 32E indicating the processing content of the jobs.

The job flow information 32 is an example of job flow information of technology disclosed herein. The information 32B is an example of information indicating a processing sequence of each of plural jobs that perform a processing series on data of technology disclosed herein. The information 32E is an example of information indicating processing content of each of plural jobs of technology disclosed herein.

In the first exemplary embodiment, the structure of the job flow information 32 is analyzed, and analysis information 34 from the analysis result and the job flow information 32 are associated with each other and registered. The analysis information 34 is information including the processing sequence of jobs to be processed in parallel when executing the series of plural jobs according to the job flow information 32. For example, the analysis information 34 includes information 34A identifying the job flow information 32, and information 34B indicating analysis completion, or non-completion of the job flow information 32, described in detail below. The analysis information 34 may further include information 34C indicating whether or not the job flow information 32 includes jobs processable in parallel, and information 34D identifying jobs processable in parallel. Accordingly, the job flow information 32 corresponding to the analysis information 34 can be identified using the information 34A of the analysis information 34. Whether or not the analysis of the job flow information 32 corresponding to the analysis information 34 has been completed can be determined using the information 34B of the analysis information 34. Whether or not a job processable in parallel is included in the job flow information 32 corresponding to the analysis information 34 can be determined using the information 34C of the analysis information 34. Whether or not jobs in the job flow information 32 corresponding to the analysis information 34 are jobs processable in parallel can be identified, and the job positions can be determined, using the information 34D of the analysis information 34.

The analysis information 34 is an example of analysis information of technology disclosed herein. The information 34C and the information 34D are examples of information indicating jobs processable in parallel in a processing series of technology disclosed herein.

The data processing system 10 is an example of a processing device including a data processing device of technology disclosed herein, and the data processing device 20 is an example of a data processing device of technology disclosed herein. The internal environment system 12 is an example of an internal environment system of technology disclosed herein, and the external environment system 14 is an example of an external environment system of technology disclosed herein.

In the data processing system 10, when business processing proceeds using a computer in the internal environment system 12, the business processing is executed based on the job flow information 32. The job flow information 32 indicates relationships between the series of plural jobs, associated with the plural jobs that perform processing on data. First, in the data processing device 20 that is included in the internal environment system 12, the structure of the job flow information 32 stored in the storage section 30 is analyzed by the analysis section 22. The analysis section 22 analyzes the job flow information 32 indicating the relationships in the series of plural jobs, and generates analysis information including the processing sequence of the series of plural jobs with respect to jobs processable in parallel by plural execution processing. When the analysis by the analysis section 22 ends, the registration section 24 of the data processing device 20 registers the analysis information 34 generated by the analysis section 22 in the storage section 30 in association with the job flow information 32 analyzed by the analysis section 22.

In the data processing system 10, in order to execute business processing based on the job flow information 32, the job flow specification section 42 specifies the execution target job flow information 32 by reading input values of an operator's input instructions or the like, or values specified by automatic processing. The execution section 44 of the job flow execution section 38 acquires the job flow information 32 specified by the job flow specification section 42 from the storage section 30, and executes business processing based on the acquired job flow information 32. By using the analysis information 34, the job flow execution section 38 increases processing efficiency of the data processing system 10 during execution of business processing based on the acquired job flow information 32

The analysis information 34 is associated with the job flow information 32 stored in the storage section 30. When, based on the analysis information 34, the processing target job is a job processed in parallel under stipulated conditions (detailed explanation is given below) during processing of each of the plural jobs indicated by the job flow information 32, the execution section 44 processes the processing target job using the external environment system 14. In the external environment system 14, data exchange with the internal environment system 12 is performed in the data exchange section 46, and execution based on data received by the data exchange section 46, namely, execution of the processing target job, is performed in the execution processing section 48. After execution of the processing target job by the execution processing section 48, a job execution result is dispatched to the internal environment system 12 by the data exchange section 46. Accordingly, in the data processing system 10, execution of business processing based on the job flow information 32 is executed distributed between the internal environment system 12 and the external environment system 14, and an increase in processing efficiency of the data processing system 10 is thereby enabled.

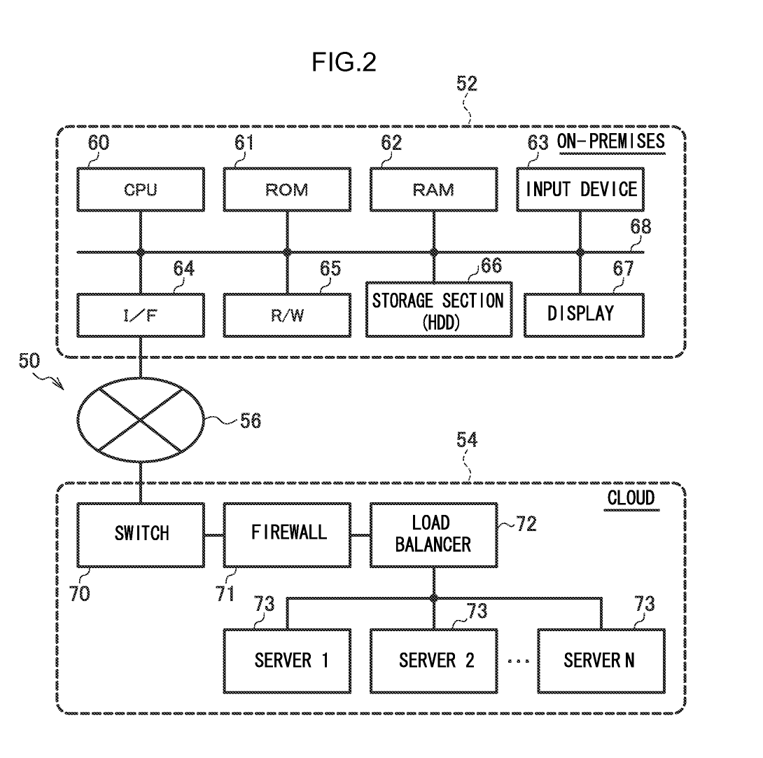

An example of a case in which the data processing system 10 is implemented by a computer system 50 serving as a data processing device is illustrated in FIG. 2. The computer system 50 includes an on-premises system 52, and a cloud system 54, and the on-premises system 52 and the cloud system 54 are connected through a communications line 56. The on-premises system 52 is an example of the internal environment system 12, and the cloud system 54 is an example of the external environment system 14.

The on-premises system 52 includes a CPU 60, ROM 61, RAM 62, and an input device 63 such as a keyboard or mouse. The CPU 60, the ROM 61, the RAM 62, and the input device 63 are mutually connected through a bus 68. The on-premises system 52 further includes an interface section (I/F) 64 for connection to the cloud system 54, a read/write section (R/W) 65, a non-volatile storage section 66, and a display section 67 that displays data, commands, or the like. The interface section (I/F) 64, the read/write section (R/W) 65, the storage section 66, and the display section 67 are mutually connected through a bus 68. Note that the read/write section 65 may be implemented by a device into which a recording medium is inserted, and that controls reading and writing of data with respect to the inserted recording medium. Moreover, the storage section 66 may be implemented by a hard disk drive (HDD), flash memory, or the like. FIG. 2 illustrates an example in which the storage section 66 is implemented by a hard disk drive (HDD). Note that input/output devices represented by the input device 63, the read/write section 65, and the display section 67 may be omitted, and may be connected by the bus 68 if required.

The cloud system 54 includes a switch 70, a firewall 71, a load balancer 72, and plural servers 73. The switch 70 is connected to the on-premises system 52 through the communications line 56, and is also connected to the firewall 71. An ETHERNET (registered trademark) switch is an example of the switch 70. The firewall 71 is connected to the load balancer 72, and the load balancer 72 is connected to each of the plural servers 73.

Although FIG. 2 illustrates an embodiment in which a single CPU 60 is provided to the on-premises system 52, the CPU 60 is not limited to a single unit, and provided that there are one or more units, any number thereof may be provided.

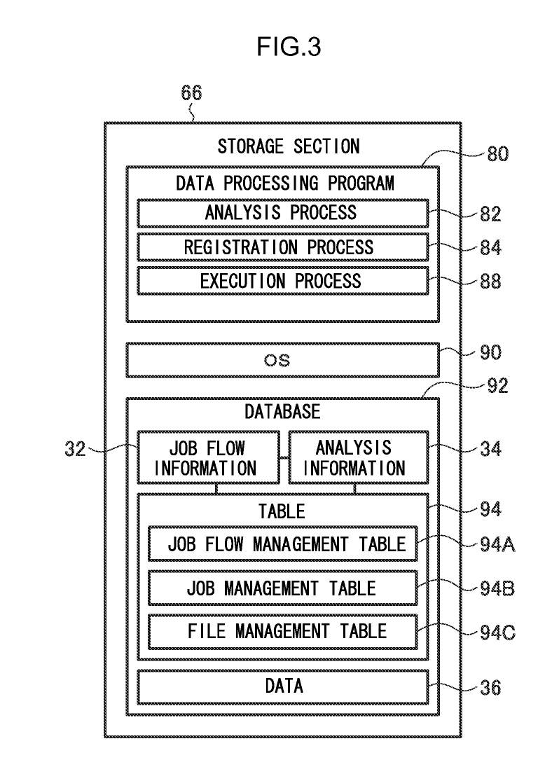

An example of information stored in the storage section 66 of the on-premises system 52 is illustrated in FIG. 3. The storage section 66 of the on-premises system 52 is stored with an OS 90 to give the function of the on-premises system 52, and a data processing program 80 that causes the on-premises system 52 to function as a data processing device. The CPU 60 reads the OS 90 from the storage section 66, expands the OS 90 into the RAM 62, and executes processing thereof. Moreover, the CPU 60 reads the data processing program 80 from the storage section 66, expands the data processing program 80 into the RAM 62, and sequentially executes the processes included in the data processing program 80. Namely, the on-premises system 52 implements the internal environment system 12, and the CPU 60 executes the data processing program 80 such that the on-premises system 52 operates as the data processing device 20 illustrated in FIG. 1.

The example illustrated in FIG. 2, in which the storage section 66 is implemented by a hard disk drive (HDD), is an example of a recording medium of technology disclosed herein.

The data processing program 80 is an example of a data processing program of technology disclosed herein. Moreover, the data processing program 80 is also a program that causes the on-premises system 52 to function as the data processing device 20.

The data processing program 80 includes an analysis process 82, a registration process 84, and an execution process 88. The CPU 60 operates as the analysis section 22 of the data processing device 20 illustrated in FIG. 1 by executing the analysis process 82. Namely, the data processing device 20 is implemented by the on-premises system 52, and the on-premises system 52 operates as the analysis section 22 of the data processing device 20 by executing the analysis process 82 of the data processing program 80. The CPU 60 operates as the registration section 24 of the data processing device 20 in the internal environment system 12 illustrated in FIG. 1 by executing the registration process 84. Namely, the internal environment system 12 is implemented by the on-premises system 52, and the on-premises system 52 operates as the registration section 24 of the data processing device 20 by executing the registration process 84. The CPU 60 operates as the job flow execution section 38 in the internal environment system 12 illustrated in FIG. 1 by executing the execution process 88. Namely, the internal environment system 12 is implemented by the on-premises system 52, and the on-premises system 52 operates as the job flow execution section 38 in the internal environment system 12 by executing the execution process 88. Note that the job flow execution section 38 includes the job flow specification section 42, and the execution section 44.

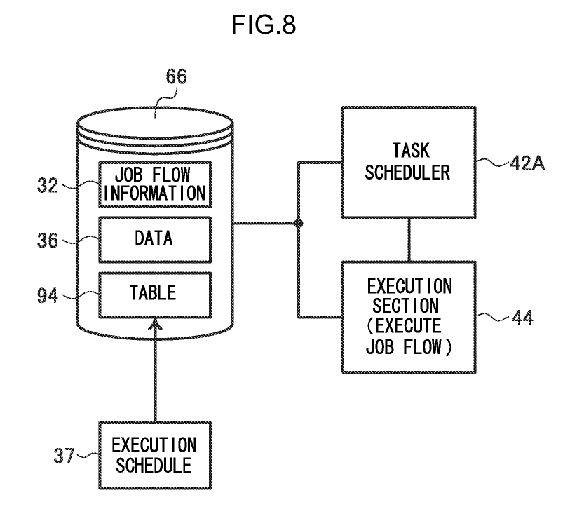

A task scheduler function is pre-included in the OS 90. The internal environment system 12 is implemented by the on-premises system 52, and the on-premises system 52 operates as a task scheduler 42A (see FIG. 8) by the CPU 60 executing the task scheduler function pre-included in the OS 90. The task scheduler 42A corresponds to the job flow specification section 42 illustrated in FIG. 1, and is capable of acquiring the job flow information 32 from the storage section 66. Moreover, the on-premises system 52 operates as the execution section 44 of the job flow execution section 38 illustrated in FIG. 1 by the CPU 60 executing the execution process 88.

The storage section 66 of the on-premises system 52 is stored with a database 92. The database 92 includes the job flow information 32, the analysis information 34, the data 36, and the tables 94. The database 92 stored in the storage section 66 of the on-premises system 52 corresponds to a portion of the storage section 30 of the internal environment system 12 illustrated in FIG. 1. Namely, when the data processing system 10 is implemented by the computer system 50, and the internal environment system 12 is implemented by the on-premises system 52, the database 92 that includes the job flow information 32, the analysis information 34, and the data 36 corresponds to the storage section 30.

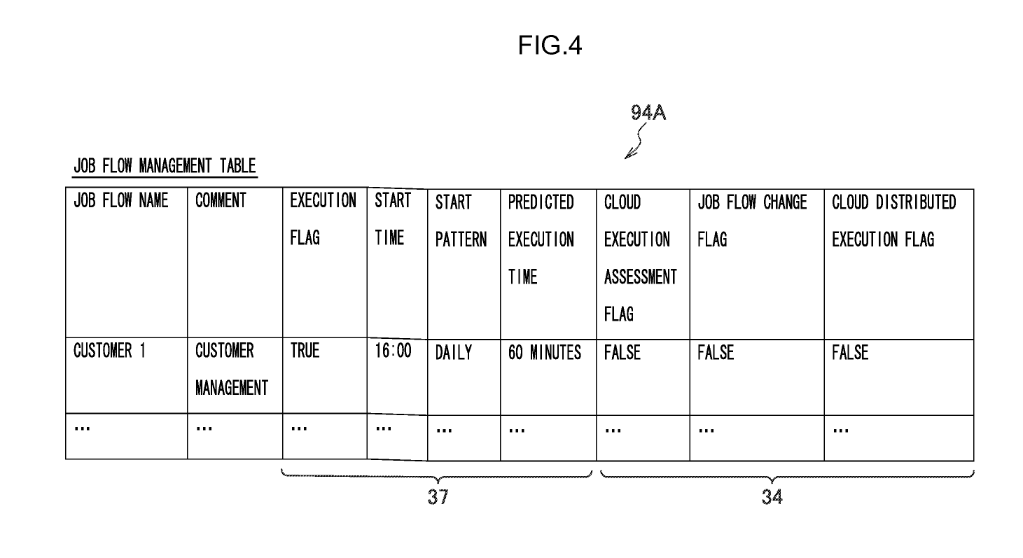

Note that the job flow information 32 and the analysis information 34, and the tables 94, are represented separately in the database 92 of the storage section 66. In the present exemplary embodiment, the job flow information 32 and the analysis information 34 are registered in the tables 94 in order to use the job flow information 32 and the analysis information 34 to simplify business processing. The tables 94 include a job flow management table 94A, a job management table 94B, and a file management table 94C, examples of which are illustrated in FIG. 4 to FIG. 6.

The job flow management table 94A is stored in the database 92 as a table of various information used when executing processing based on the job flow information 32.

FIG. 4 illustrates an example of the job flow management table 94A. The job flow management table 94A registers respective information of a “job flow name”, a “comment”, and an “execution flag”, each associated with one another. Moreover, the job flow management table 94A registers respective information of a “start time”, a “start pattern”, an “estimated execution duration”, a “cloud execution assessment flag”, a “job flow change flag”, and a “cloud distributed execution flag”, each associated with one another.

The information indicated by the “job flow name” item in the job flow management table 94A illustrated in FIG. 4 is information indicating identifiers such as titles that identify individual job flow information 32 to the operator. In the example of FIG. 4, “customer 1” is stored as the “job flow name” item. Moreover, the information represented by the “comment” item is information that indicates a generic name for the business processing related to the job flow information 32 in order for the operator to confirm the content of the job flow information 32. In the example of FIG. 4, “customer management” is stored as the “comment” item.

The information indicated by the “execution flag” item is information that indicates whether or not the job series according to the job flow information is to be executed as a task, and is described in detail below. For the information value represented by the “execution flag” item, “FALSE” indicates no task execution, and “TRUE” indicates that a task is to be executed according to the schedule. The information representing the “start time” item is information that indicates a time to start processing using the job flow information 32 according to the schedule. In the example of FIG. 4, “16:00” is stored as the “start time” item.

In the following explanation, sometimes explanation is given for each flag type of setting the “flag” as ON in order to store the flag value as “TRUE”, and setting the “flag” as OFF in order to store the flag value as “FALSE”.

The information represented by the “start pattern” item is information indicating an execution pattern relating to an execution time such as a date, or a weekly time, when business processing, namely processing according to the job flow information 32, is executed periodically. In the example of FIG. 4, “daily” is stored as the “start pattern” item. The information represented by the “estimated execution duration” item is information indicating an estimated time obtained by pre-measuring or the like, and is the required time for processing according to the job flow information 32. In the example of FIG. 4, a required time of “60 minutes” is stored as the “estimated execution duration” item.

The stored information representing the “cloud execution assessment flag” item is information indicating whether or not assessment has been completed on the job flow information 32 of whether or not a job is included that is executable in the external environment system 14, for example a cloud environment. In the example of FIG. 4, “FALSE” is stored as the “cloud execution assessment flag” item. Note that information of “TRUE” indicates that the assessment has been completed. Conversely, information of “FALSE” indicates that the assessment is incomplete.

The information representing the “job flow change flag” item is information indicating whether or not a change has been made to the job flow information 32. In the example of FIG. 4, a value of “FALSE” is stored as the “job flow change flag” item. Note that “FALSE” is a value stored when a change has been made to the time of creation of the job flow information 32, or the job flow information 32. Moreover, “FALSE” indicates that assessment (analysis) of the job flow information 32 is incomplete, namely, that assessment has not been completed on the job flow information 32 of whether or not a job is included that is executable in the external environment system 14, for example a cloud environment. Conversely, “TRUE” is a value stored when the job flow information 32 has not changed, and assessment (analysis) of the job flow information 32 is complete.

Accordingly, the same value is stored as the information representing the “cloud execution assessment flag” item, and the “job flow change flag” item when assessment has not been completed on the job flow information 32 of whether or not a job is included that is executable in the external environment system 14, for example a cloud environment. In the explanation that follows, the value that represents the “job flow change flag” item is used to determine whether or not assessment has been completed on the job flow information 32 of whether or not a job is included that is executable in the external environment system 14, for example a cloud environment.

The information representing the “cloud distributed execution flag” item is information indicating whether or not the job flow information 32 includes a job that is executable in the external environment system 14, for example a cloud environment. In the example of FIG. 4, “FALSE” is stored as the “cloud distributed execution flag” item. Note that “TRUE” indicates that the job flow information 32 includes a job that is executable in the external environment system 14. Conversely, “FALSE” indicates that the job flow information 32 is not executable in the external environment system 14 and includes only jobs that are executable in the internal environment system 12.

Note that the job flow management table 94A includes an example of the analysis information of technology disclosed herein. The job flow information 32 may be identified by the information representing the “job flow name” item. The job flow information 32 identified by the information representing the “job flow name” item is associated with the respective information of the “cloud execution assessment flag”, the “job flow change flag”, and the “cloud distributed execution flag”. The respective information of the “cloud execution assessment flag”, the “job flow change flag”, and the “cloud distributed execution flag” are information included in information indicating jobs processable in parallel in a processing series.

An example of information related to job flow execution is displayed in the job flow management table 94A. In a job flow, for the job flow information 32 identified by the information representing the “job flow name” item, processing with a time estimated by the “estimated execution duration” is executed when the “execution flag” thereof is “TRUE” under the conditions of the “start time” and the “start pattern”. Note that in the explanation that follows, a unit of business processing, in which a job series is executed by a computer based on the job flow information 32, is referred to as a task. Namely, a job series according to job flow information is referred to as a task.

Namely, the information representing the “job flow name” item in the job flow management table 94A illustrated in FIG. 4 corresponds to the information 32A (FIG. 1) that identifies the business processing included in the job flow information 32. Moreover, in the job flow management table 94A illustrated in FIG. 4, the information representing the “job flow name” item also corresponds to the information 34A (FIG. 1) that identifies the job flow information 32 included in the analysis information 34. In the job flow management table 94A illustrated in FIG. 4, the information representing the “cloud execution assessment flag” item, and the information representing the “job flow change flag” item correspond to the information 34B that indicates whether the analysis of the job flow information 32 is complete or incomplete. The information representing the “cloud distributed execution flag” item in the job flow management table 94A illustrated in FIG. 4 corresponds to the information 34C that indicates whether or not the job flow information 32 included in the analysis information 34 includes a job processable in parallel.

The job management table 94B is stored in the database 92 as a table of information indicating the detailed content of jobs indicated by the job flow information 32.

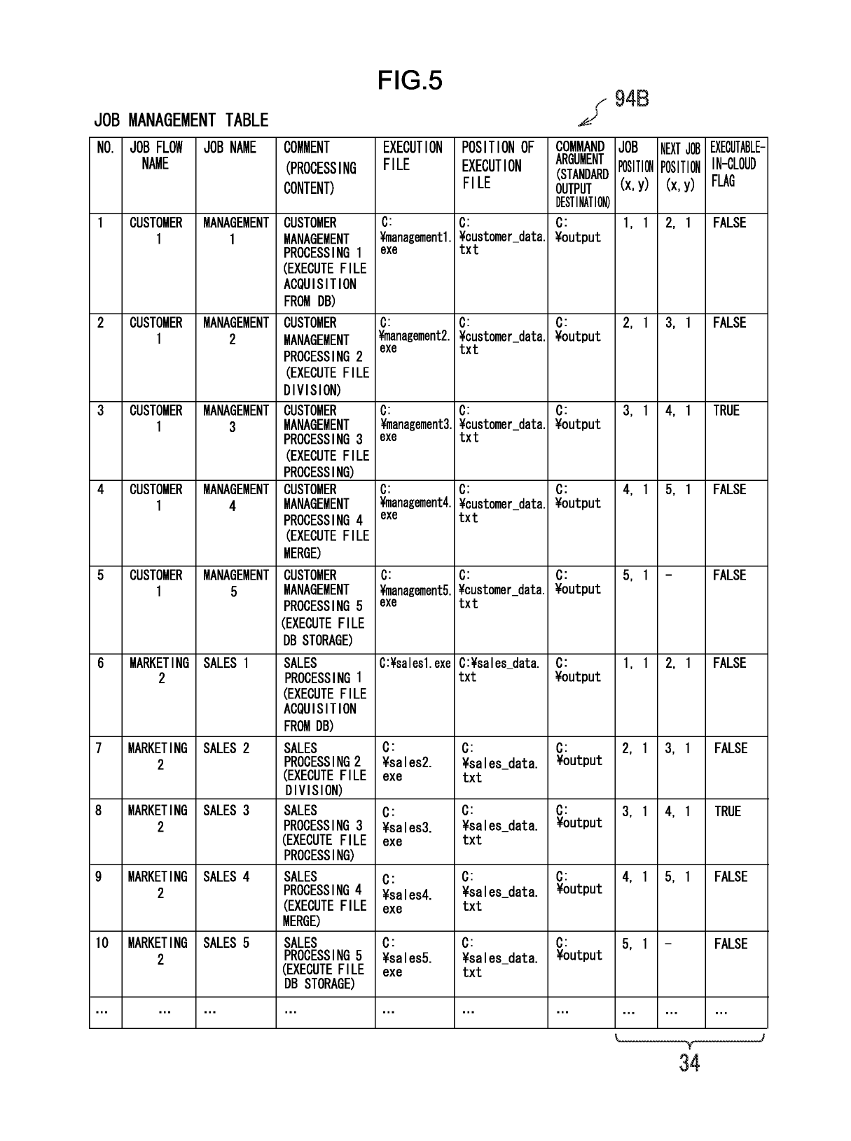

An example of the job management table 94B is illustrated in FIG. 5. The job management table 94B indicates detailed content relating to the series of plural jobs included in each job flow information 32 registered in the database 92. Respective information of “No.”, the “job flow name”, the “job name”, and the “comment”, are registered associated with one another in the job management table 94B. Respective information of an “execution file”, an “execution file position”, a “command argument”, a “job position”, a “next job position”, and an “executable-in-cloud flag” are registered in the job management table 94B associated with one another.

The information indicating the “No.” item in the job management table 94B illustrated in FIG. 5 indicates the table position of the job in the job management table 94B. The information indicating the “job flow name” item is information indicating the job flow information 32 in which the jobs managed by the job management table 94B are included. The information indicating the “job name” item is information indicating identifiers such as titles of individual jobs that identify the jobs included in the job flow information 32. In the example of FIG. 5, “customer 1” is stored as the “job flow name” item, and “management 1” is stored as the “job name” item for the job indicated by a “No.” item of “1”.

The information indicating the “comment” item is information indicating processing titles or the like indicating processing content of jobs included in the job flow information 32. In the example of FIG. 5, “customer management processing 1” is stored as the “comment” item for the job indicated by a “No.” item of “1”. Note that in FIG. 5, information indicating processing content of jobs is stored in parentheses in the information indicating the “comment” item. The processing content of a job, such as “execute file acquisition from DB” for example, is expressed as information using ordinary descriptive language, or language common between systems.

The information indicating the “execution file” item is information indicating the file name of the execution file that executes processing according to the jobs included in the job flow information 32. The information indicating the “execution file position” item is information indicating a storage position of the execution file that executes the processing according to the job. The information indicating the “command argument” item is information that, for each execution of an execution file corresponding to a job, indicates execution time options of the execution file.

The information indicating the “job position” item is information indicating the position of the job in the job flow information 32. The information indicating the “next job position” item is information that indicates the position of the next job in the job flow information 32 following the job represented by the job position. The information indicating the “executable-in-cloud flag” item is information indicating whether or not the job is executable in a cloud environment. In the example illustrated in FIG. 5, explanation is given regarding the job indicated by the “No.” item of “1”. The job indicated by the “No.” item of “1” is a job included in the job flow information 32 indicated by the job flow name of “customer 1”, and has the job name “management 1”. The processing content of the job indicated by the “No.” item of “1” is the content indicated by “customer management processing 1”. Moreover, in the job of the “No. 1” item with the job name “management 1” the execution file “C:┌management 1.exe” is executed for which the position is indicated as “C: ┌customer_data.txt”. When executing the execution file “C: ┌management 1.exe”, execution is performed with an option set as a command argument represented by “C: ┌output”. Note that FIG. 5 illustrates an example of information indicating a standard output destination as information represented by “C: ┌output” as the command argument.

Moreover, it is indicated that the job of the “No. 1” item with job name “management 1” has a position x of “1”, and a position y of “1” in the job flow information 32 indicated by “customer 1”. Position x indicates the processing sequence with respect to relationships in the series of plural jobs indicated by the job flow information 32. Position y indicates a sequence when plural processing accompanies the processing at position x. Moreover, in the example of FIG. 5, an example is illustrated in which position x and position y are “2, 1” for the information indicating the “next job position” item. Moreover, an example is illustrated in which information of “FALSE” is stored as the information indicating the “executable-in-cloud flag”. Note that “FALSE” indicates that the job of the “No. 1” item with job name “management 1” is not executable in a cloud environment. Conversely, “TRUE” indicates that a job is executable in a cloud environment.

The information indicating the “job flow name” item in the job management table 94B illustrated in FIG. 5 corresponds to the information 32A (FIG. 1) that identifies the business processing included in the job flow information 32. The information indicating the “job flow name” item moreover corresponds to the information 34A (FIG. 1) that identifies the job flow information 32 included in the analysis information 34. The information indicating the “job name” item corresponds to the information 32C (FIG. 1) that identifies the respective jobs included in the job flow information 32. The information of the “comment” item corresponds to the information 32E (FIG. 1) indicating processing content of the respective jobs included in the job flow information 32. The information of the “execution file” item, or the “execution file” item, the “execution file position” item, and the “command argument” item respectively, correspond to the information 32D (FIG. 1) indicating the execution file that executes processing of the respective jobs included in the job flow information 32. The information of the “job position” item, and the “next job position” item correspond to the information 32B (FIG. 1) indicating the proceeding/following relationships in the series of plural jobs included in the job flow information 32. The information of the “executable-in-cloud flag” item corresponds to the information 34D (FIG. 1) that identifies jobs processable in parallel included in the analysis information 34. The information of the “job position” item and the “next job position” item may be included in the information 34D (FIG. 1) that identifies jobs processable in parallel included in the analysis information 34.

The job management table 94B includes an example of the analysis information of the technology disclosed herein. Which job flow information 32 a job is included in may be identified by the information indicating the “job flow name”. Jobs in the job flow information 32 are associated with the respective information of the “job position”, the “next job position”, and the “executable-in-cloud flag”. The respective information of the “job position”, the “next job position”, and the “executable-in-cloud flag” are examples of information indicating jobs processable in parallel in the processing series and examples of information indicating the processing sequence of the jobs processable in parallel.

In order to increase the processing efficiency of a processing device such as the computer system 50, the file management table 94C is pre-stored in the database 92 as a table of conditions for the job flow information 32. The file management table 94C indicates conditions for when the job flow information 32 increases processing efficiency of the processing device. Namely, the file management table 94C contains conditions for determining whether or not each respective job included in the job flow information 32 is a job with a structure conforming to the stipulated conditions for increasing processing efficiency of the processing device. For example, in the conditions relating to the job flow information 32, there is a table stored with predetermined values for information indicating the structure of the job flow information 32. Examples of information indicating the structure of the job flow information 32 include information indicating the number of jobs serving as targets for increasing the processing efficiency of the processing device included in the job flow information 32, and information indicating proceeding/following relationships between each job that represent the execution sequence in the series of jobs. Moreover, information relating to the content of respective jobs may be associated with information indicating the structure of the job flow information 32. Processing content of execution files for respective jobs, files employed by respective jobs, and information indicating input/output relationships of respective jobs serve as examples of the information relating to the content of respective jobs.

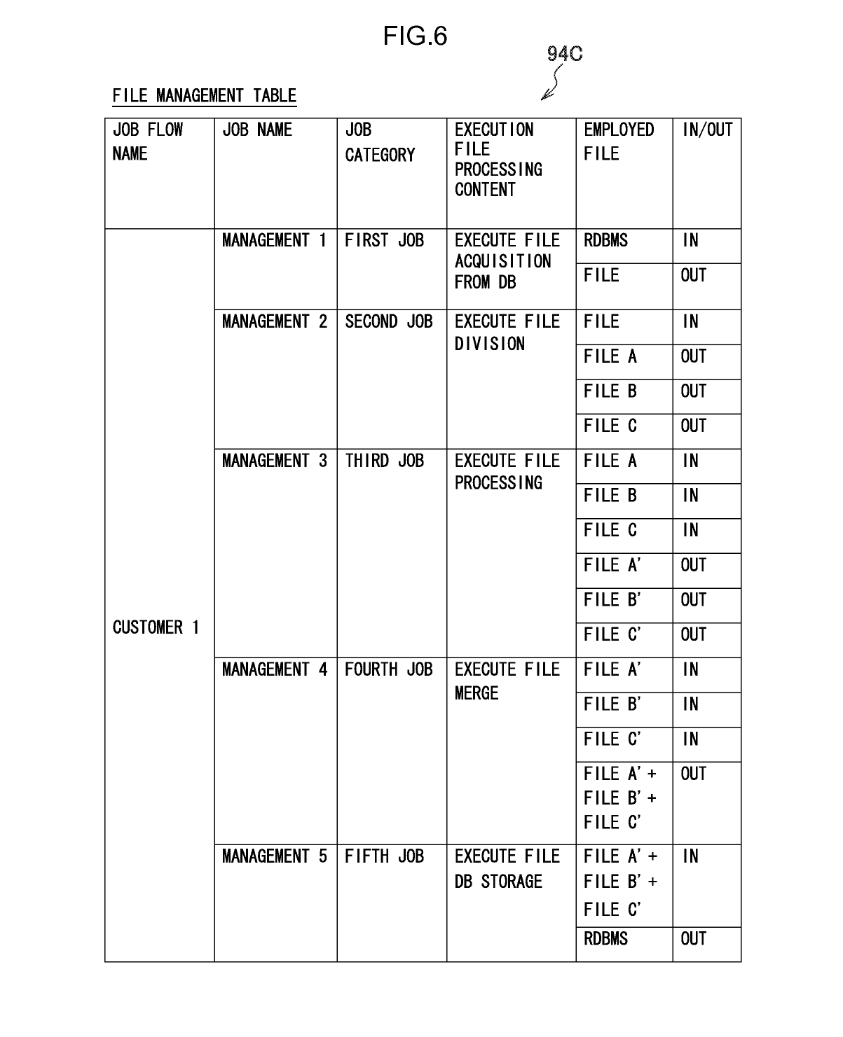

FIG. 6 illustrates a file management table 94C representing an example of structure conditions for increasing processing efficiency for processing based on the job flow information 32. Respective information of a “job classification”, “execution file processing content”, an “employed file”, and “in/out” are registered associated with one another in the file management table 94C illustrated in FIG. 6. The information indicating the “job classification” item in the file management table 94C is information indicating the classification of processing of job units to be processed in the job flow information 32. Information indicating the “execution file processing content” item is information indicating the execution file processing content during execution of respective jobs. The information indicating the “employed file” item is information indicating files such as data or files employed during job execution. Information that indicates the employed file indicates an employed file that will serve as input if the information representing the “in/out” item is “in”, and an employed file that will serve as output if the information representing the “in/out” item is “out”.

In FIG. 6 an example is illustrated in which there are 5 jobs in the series of plural jobs included in the job flow information 32. A case is illustrated in which a “first job” has “execute file acquisition from DB” as processing content, an employed file of “RDBMS” as input, and an employed file of “file” as output. DB is an abbreviation of database. Moreover, RDBMS refers to data from software that manages a relational database, namely, is an abbreviation of relational database management software. A case is illustrated in which a “second job” has processing content of “execute file division”, has an employed file of the output “file” of the first job as input, and employed files of divided files “file A, file B, file C” as output. A case is illustrated in which a “third job” has processing content of “execute file processing”, employed files of the output “file A, file B, file C” of the second job as input, and processed files “file A′, file B′, file C′” as output. A case is illustrated in which a “fourth job” has processing content of “execute file merge”, has employed files of the output “file A′, file B′, file C′” of the third job as input, and an employed file of file merged “file A′+file B′+file C′” as output. A case is illustrated in which a “fifth job” has processing content of “execute file storage in DB”, has an employed file of the output “file A′+file B′+file C′” of the fourth job as input, and an employed file of “RDBMS” as output.

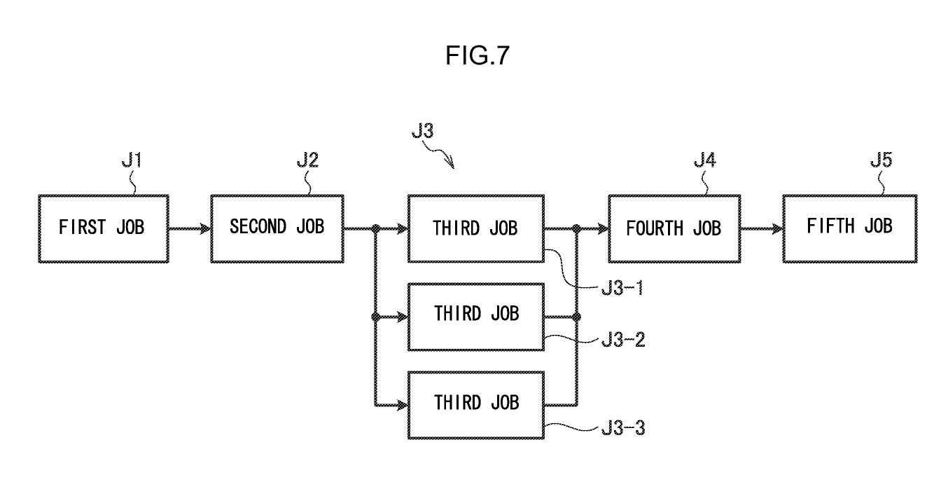

FIG. 7 schematically illustrates the file management table 94C illustrated in FIG. 6 according to the structure of the proceeding/following relationships of the job units included in the job flow information 32. The example of the job flow information 32 illustrated in FIG. 7 has a structure in which, respective jobs are associated with one another in the sequence first job J1, second job J2, third job J3, fourth job J4, fifth job J5. The third job J3 includes sub-jobs J3-1, J3-2, and J3-3 that perform matching or substantially similar jobs.

Explanation follows regarding processing in the job flow execution section 38 of the data processing system 10 illustrated in FIG. 1 that specifies the job flow information 32 using the job flow specification section 42.

The internal environment system 12 includes the storage section 30, and the job flow execution section 38, and specifies the job flow information 32 using the job flow specification section 42 of the job flow execution section 38, and the job flow is executed by the execution section 44 using the specified job flow information 32. The analysis information 34 of technology disclosed herein is not strictly necessary for cases in which only job flow information 32 corresponding to a job flow of a standard execution target is specified when job flow information 32 is specified by the job flow specification section 42. Namely, it is sufficient for the storage section 66 of the computer system 50 to include the job flow information 32, and the data 36, and also the table 94 that includes data recorded with a timing for execution of the job flow.

FIG. 8 illustrates as a block diagram processing that specifies the job flow information 32 in cases in which the internal environment system 12 illustrated in FIG. 1 is implemented by an on-premises system 52. The storage section 66 includes the job flow information 32, the target data 36, and the table 94. The on-premises system 52 operates as the task scheduler 42A by the CPU 60 executing the task scheduler function pre-included in the OS 90. The task scheduler 42A illustrated in FIG. 8 corresponds to the job flow specification section 42 illustrated in FIG. 1. The task scheduler 42A acquires the job flow information 32 from the storage section 66. The on-premises system 52 operates as the execution section 44 of the job flow execution section 38 illustrated in FIG. 1 by the CPU 60 executing the execution process 88.

In order to simplify explanation, explanation is given of a case in which the job flow information 32 is pre-generated, and the generated job flow information 32 is already stored in the storage section 66 (the storage section 30 of the internal environment system 12). Moreover, the table 94 includes data recorded with a timing for execution of the job flow. For example, an example of an execution schedule 37 is illustrated by the job flow management table 94A illustrated in FIG. 4. The job flow information 32 may be specified using the information indicating the “job flow name” item. The job flow information 32 specified using the information indicating the “job flow name” item is associated with the respective information of the “execution flag”, the “start time”, the “start pattern”, and the “estimated execution duration”. Accordingly, job flows are executed at pre-specified timings by executing the job flow information 32 of a job flow name for which the “execution flag” is “true” at the “start time” and with the “start pattern”.

The task scheduler 42A executes the job flow, namely, with the job processing series according to the job flow information 32 as a task, the task scheduler 42A instructs the execution section 44 to execute the specified task at a time specified by the execution schedule 37. The execution section 44 processing is executed according to the task specified by the task scheduler 42A using the job flow information 32 of the storage section 66, namely, processing of the series of plural jobs based on the job flow information 32.

When generating the job flow information 32 anew, specification of the job flow execution time according to the job flow information 32 may be achieved by storing an input value for the job flow execution time input by input instructions of an operator or the like in the execution schedule 37.

Explanation follows regarding operation of the present exemplary embodiment.

In the present exemplary embodiment, the relationships of the series of plural jobs indicated by the job flow information 32 are analyzed to increase processing efficiency of a processing device that processes jobs based on the job flow information 32. The analysis of the job flow information 32 generates analysis information including the processing sequence of the series of plural jobs for plural jobs to be processed in parallel by the execution processing. The generated analysis information is registered associated with the analyzed job flow information. The processing device processes the jobs based on the job flow information associated with the analysis information. Namely, in the on-premises system 52 processing is executed according to the analysis process 82 included in the data processing program 80.

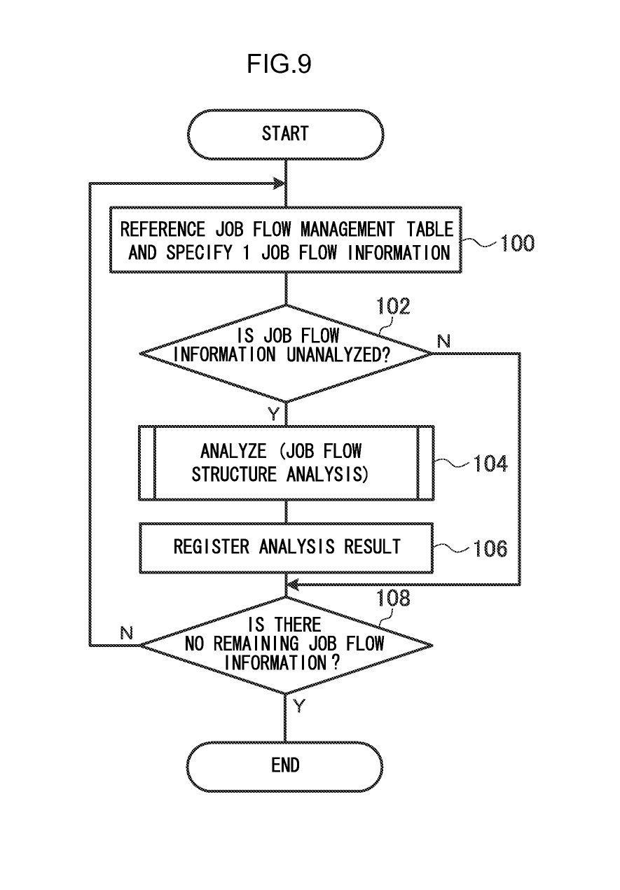

A flow of the analysis process 82 included in the data processing program 80 executed by the on-premises system 52 is illustrated in FIG. 9. The on-premises system 52 operates as the analysis section 22 of the data processing device 20 in the internal environment system 12 by executing the analysis process 82 in the on-premises system 52, and executes the analysis processing of the job flow information 32. The processing routine illustrated in FIG. 9 is executed repeatedly at a prescribed time interval during operation of the on-premises system 52. Namely, the CPU 60 of the on-premises system 52 executes the processing routine illustrated in FIG. 9 each time a prescribed time has elapsed. Note that the processing routine illustrated in FIG. 9 is not limited to repeated execution, and may be executed according to an operating instruction of the input device 63 by the user.

At step 100, the CPU 60 of the on-premises system 52 references the job flow management table 94A, and specifies a single job flow information 32. The specification of the job flow information 32 at step 100 is task scheduler 42A specification by the CPU 60 executing the scheduler function pre-included in the OS 90. Note that the task scheduler 42A specifies one of the job flow information 32 registered in the job flow management table 94A, and may be specification using a predetermined sequence, or specification at random (arbitrarily). At the next step 102, the CPU 60 determines for the job flow information 32 specified at step 100 whether or not the job flow information 32 is unanalyzed. Namely, at step 102, the information of the “job flow change flag” item in the job flow management table 94A is referenced for the job flow information 32 specified at step 100. Namely, at step 102, whether or not the job flow information 32 is unanalyzed is determined by deciding whether or not the value of the referenced “job flow change flag” is “FALSE”.

Affirmative determination is made at step 102 when the value of the “job flow change flag” item is “FALSE”, and transition is made to step 104. However, negative determination is made at step 102 when the value of the “job flow change flag” is “TRUE”, and transition is made to step 108.

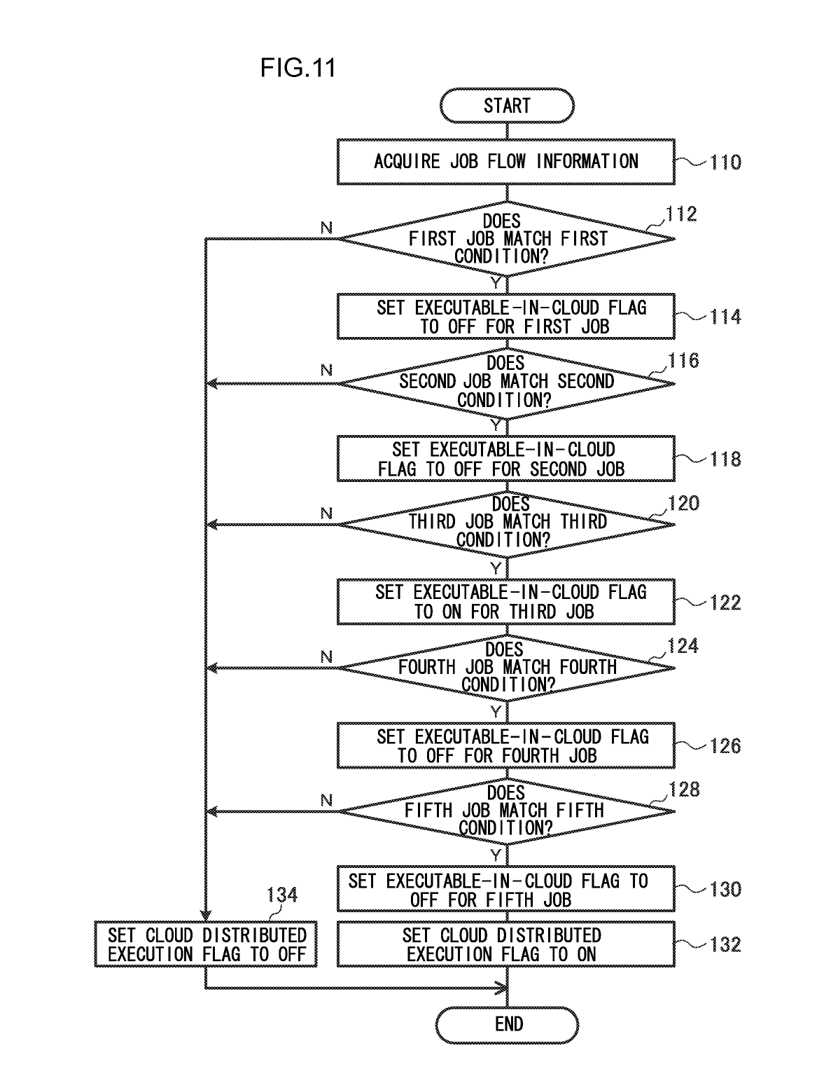

At step 104, the CPU 60 executes the analysis processing. The analysis processing of step 104 is processing that analyzes the structure of the job flow information 32, described in detail below (FIG. 11). When the analysis processing of step 104 has been completed, at the next step 106 the CPU 60 registers the analysis result of step 104 in the storage section 66. The analysis result includes the analysis information 34, and registration of the analysis information 34 in the storage section 66 corresponds to registration of the analysis information 34 in the storage section 30 of the internal environment system 12 illustrated in FIG. 1.

Next, at step 108, the CPU 60 determines whether or not there is remaining job flow information 32 by deciding whether or not the analysis processing has been completed for all of the job flow information 32 registered in the job flow management table 94A. Affirmative determination is made at step 108 when analysis processing has been completed for all of the job flow information 32 registered in the job flow management table 94A, and the processing routine is ended. However, negative determination is made at step 108 when job flow information 32 remains in the job flow management table 94A for which analysis processing is incomplete, processing returns to step 100, another job flow information 32 is specified, and the processing of steps 102 to 106 are executed again.

Explanation follows regarding analysis processing of step 104 illustrated in FIG. 9. The analysis processing is processing that analyzes the structure of the job flow information 32 from relationships in the series of plural jobs indicated by the corresponding job flow information 32.

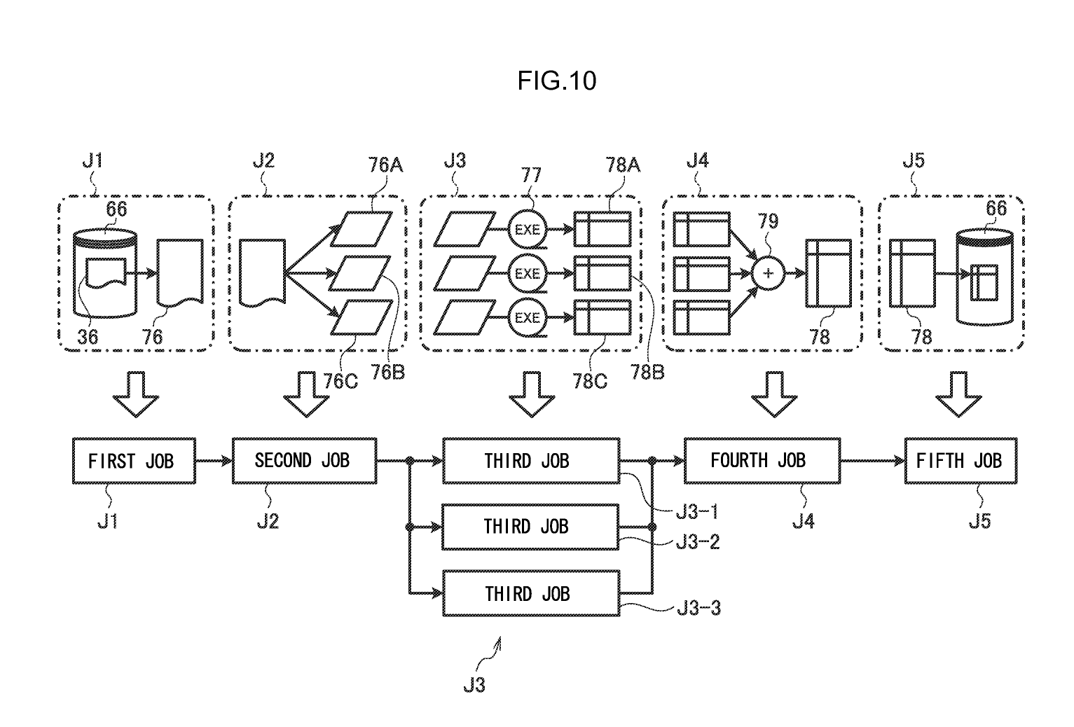

FIG. 10 is a schematic illustration including an example of structure analysis of the job flow information 32 as a processing schematic for each of the jobs. In the example of FIG. 10 the first job J1 indicates acquisition processing of a file, the second job J2 indicates division processing of the file, the third job J3 indicates work processing on the files, the fourth job J4 indicates combination processing of the files, and the fifth job J5 indicates storage processing of the file.

In the first job J1, a file 76 such as a flat file is acquired from the storage section 66, namely from the data 36 included in the database 92. The first job J1 corresponds to the structure conditions of the first job in the file management table 94C illustrated in FIG. 6. In the second job J2, the file 76 such as a flat file acquired by the first job J1 is divided into three divided files 76A, 76B, and 76C. The second job J2 corresponds to the structure conditions of the second job in the file management table 94C illustrated in FIG. 6. Namely, the first job J1 acquires an employed file as input, and the acquired employed file is output as the file 76. The second job J2 takes the file 76 output by the first job J1 as input, and divides the file into three divided files 76A, 76B, 76C which are then output. Accordingly, the first job J1 and the second job J2 can be analyzed as being associated with each other as jobs with a sequential processing structure.

In the third job J3, predetermined specification processing 77 is performed on the respective divided files 76A, 76B, 76C divided by the second job J2, and processed files 78A, 78B, 78C are obtained. Namely, as the specific processing 77 in the third job J3, processing is performed on the respective divided files 76A, 76B, 76C by the sub-jobs J3-1, J3-2, and J3-3 that perform matching or substantially similar jobs. The third job J3 corresponds to the structure condition of the third job in the file management table 94C illustrated in FIG. 6. Namely, the third job J3 takes the respective divided files 76A, 76B, 76C divided by the second job J2 as input, performs the specific processing 77 on the respective divided files 76A to 76C, and then outputs respective processed files 78A, 78B, 78C. Accordingly, the second job J2, and the third job J3 can be analyzed as sequentially processed jobs with a structural association. Moreover, the third job J3 can be analyzed as having a parallel processing structure through sub-jobs J3-1, J3-2, and J3-3.

In the fourth job J4, the processed files 78A, 78B, 78C that have been processed by the third job J3 are combined using combination processing 79, and a combined file 78 is obtained. The fourth job J4 corresponds to the structure condition of the fourth job in the file management table 94C illustrated in FIG. 6. Namely, the fourth job J4 takes the respective processed files 78A to 78C processed by the third job J3 as input, and combines the files into a combined file 78 which is then output. Accordingly, the third job J3, and the fourth job J4 can be analyzed as being associated with each other as jobs with a sequentially processing structure.

In the fifth job J5, the combined file 78 combined by the fourth job J4 is stored in the storage section 66. The fifth job J5 corresponds to the structure condition of the fifth job in the file management table 94C illustrated in FIG. 6. Namely, the fifth job J5 takes the combined file 78 combined by the fourth job J4 as input, and stores the combined file 78 in the storage section 66 as output. Accordingly, the fourth job J4 and fifth job J5 can be analyzed as being associated with each other as jobs with a sequentially processing structure.

Note that in the example of the structure of the job flow information 32 illustrated in FIG. 10, the respective processing of the first job J1, the second job J2, the fourth job J4, and the fifth job J5 is processed in the on-premises system 52. Moreover, the third job J3 includes plural processing (sub-jobs J3-1 to J3-3) processable in parallel, and at least a portion of the processing (any or all of sub-jobs J3-1 to J3-3) is processable in the cloud system 54.

Further detailed explanation follows regarding the analysis processing of step 104 illustrated in FIG. 9. The CPU 60 of the on-premises system 52 executes the analysis processing of the job flow information 32 by reading the analysis process 82 from the storage section 66, expanding the analysis process 82 into the RAM 62, and executing the analysis processing of the job flow information 32.

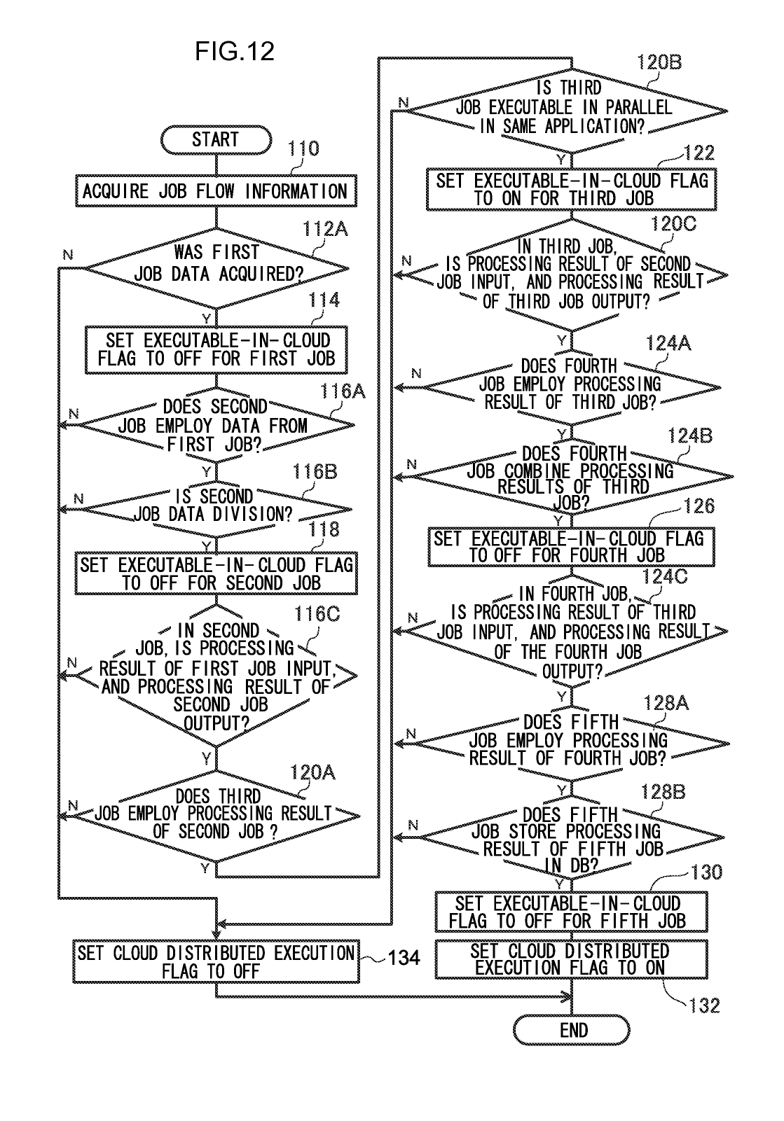

An example of a flow of the analysis processing of step 104 illustrated in FIG. 9 is illustrated in FIG. 11, and FIG. 12 illustrates an example of the flow of processing of FIG. 11 in which more specific processing is illustrated for part thereof. The processing of the analysis process 82 is processing that analyzes the structure of the job flow information 32. Moreover, the processing of the analysis process 82 analyzes the structure of the job flow information 32 included in the jobs to be processed in parallel by the plural execution processes, and includes processing that obtains the analysis information of the analysis result as information for increasing processing efficiency of the on-premises system 52. The information for increasing processing efficiency of the on-premises system 52 is information indicating that a portion of the processing of the on-premises system 52 is processable in the cloud system 54.

The CPU 60 executes the analysis processing (step 104), and acquires the job flow information 32 at step 110 of FIG. 11. The job flow information 32 acquired at step 110 is the job flow information 32 specified at step 100 illustrated in FIG. 9. Namely, the job flow information 32 corresponding to the job flow information 32 specified at step 100 illustrated in FIG. 9 is extracted from the job flow management table 94A illustrated in FIG. 4, and the job management table 94B illustrated in FIG. 5. At the next step 112 the CPU 60 determines whether or not the first job included in the job flow information 32 matches the first condition. The determination at step 112 employs the structure condition registered in the file management table 94C. Namely, determination is made as to whether or not the first job of the job flow information 32 acquired at step 110 matches the structure condition of the first job registered in the file management table 94C. For example, when the job flow name is “customer 1”, the first job in the acquired job flow information 32 can be identified as the job with job name “management 1” from the respective information of the “comment (processing content)” item, the “job position” item, and the “job target” (see FIG. 5). The processing content of the first job with job name “management 1” is “acquire file from DB”, and is processing to send the next job. The structure condition of the first job registered in the file management table 94C indicates that the first job is a file acquisition process, and is a job that acquires the RDBMS as input and outputs the acquired file as the file 76 (FIG. 10). Accordingly, when for example, the job flow information 32 with job flow name “customer 1” is specified, at step 112 the CPU 60 determines that the first job included in the job flow information 32 matches the first condition. Note that FIG. 12 illustrates an example in which the determination processing of step 112 illustrated in FIG. 11 is substituted by determination processing that determines whether or not the first job J1 is “data acquisition”

When negative determination is made at step 112, processing proceeds to step 134, the cloud distributed execution flag is set to OFF, and the processing routine is ended. Namely, the job flow information 32 of the analysis target does not match a predetermined structure (see FIG. 7, FIG. 10) for increasing processing efficiency of the on-premises system 52, and so the cloud distributed execution flag is set to OFF. In the registration processing (step 106 illustrated in FIG. 9) following the end of the processing routine, the value of the cloud distributed execution flag is registered in the storage section 66 as an analysis result. Namely, each value of the “cloud execution assessment flag”, “job flow change flag”, and “cloud distributed execution flag” items (see FIG. 4) of the job flow information 32 of the analysis target are registered in the job flow management table 94A. Specifically, “TRUE” is registered as the value of the “cloud execution assessment flag” and the “job flow change flag”, and “FALSE” is registered as the value of the “cloud distributed execution flag”.

Analysis continues when affirmative determination is made at step 112, since the first job included in the job flow information 32 of the analysis target matches the predetermined structure (see FIG. 7, and FIG. 10) for increasing the processing efficiency of the on-premises system 52. Namely, since the first job J1 is to be processed in the on-premises system 52, the CPU 60 sets the executable-in-cloud flag for the first job J1 to OFF at step 114, and processing proceeds to step 116.

Next, the CPU 60 determines at step 116 whether or not the second job J2 matches a second condition. The determination at step 116 employs the structure condition registered in the file management table 94C. Namely, determination is made as to whether or not the second job of the job flow information 32 acquired at step 110 matches the structure condition of the second job registered in the file management table 94C. For example, when the job flow name is “customer 1”, the second job in the acquired job flow information 32 can be identified as the job with the job name “management 2”, from respective information of the “comment (processing content)”, “job position”, and “next job position” items (see FIG. 5). The processing content of the second job with the job name “management 2” is “file division”, and is processing to send the respective divided files to the next job. The structure condition of the second job registered in the file management table 94C indicates that the second job is file division processing, takes the output file of the first job as input, and outputs the divided files 78A, 78B, 78C (see FIG. 10) of the divided input file. Accordingly, for example, when the job flow information 32 with the job name “customer 1” is specified, at step 116, the CPU 60 determines that the second job included in the job flow information 32 matches the second condition.

An example of determination processing of step 116 is determination made as to whether or not plural determination conditions are matched. For example, the determination processing of step 116 illustrated in FIG. 1 may be substituted by determination processing according to the condition determinations of steps 116A, 116B, 116C illustrated in FIG. 12. The first condition determination indicates whether or not the second job J2 included in the job flow information 32 is “a job that employs data output from the first job J1” (step 116A illustrated in FIG. 12). The second condition indicates whether or not the second job J2 included in the job flow information 32 is a “data division job” (step 116B illustrated in FIG. 12). A third condition indicates whether or not the second job J2 included in the job flow information 32 is a “job that is input with the data output from the first job J1 and outputs the processing result of the second job J2” (step 116C illustrated in FIG. 12). Affirmative determination at step 116 of FIG. 11 corresponds to when affirmative determinations are made at the condition determination of all of steps 116A, 116B, and 116C illustrated in FIG. 12. Note that the condition determinations of steps 116A, 116B, and 116C illustrated in FIG. 12 are not limited to the sequence illustrated in FIG. 12. Although FIG. 12 illustrates a case which processing transitions to the condition determination of step 116C after step 118, step 118 and step 116C may be interchanged in sequence.

When negative determination is made at step 116, the cloud distributed execution flag is set to OFF at step 134, and the processing routine is ended. However, when affirmative determination is made at step 116, the CPU 60 sets the executable-in-cloud flag for the second job J2 to OFF at step 118, and analysis continues. Namely, in a predetermined structure of the job flow information 32 (see FIG. 7, and FIG. 10), the second job J2 is processed in the on-premises system 52. Accordingly, the CPU 60 sets the executable-in-cloud flag for the second job J2 to OFF at step 118, and processing proceeds to step 120.

Next, the CPU 60 determines at step 120 whether or not the third job J3 matches the third condition. Determination at step 120 employs the structure conditions registered in the file management table 94C. Namely, determination is made as to whether or not the third job of the job flow information 32 acquired at step 110 matches the structure condition of the third job registered in the file management table 94C. For example, the third job in the job flow information 32 with the job flow name “customer 1” can be identified as the job with the job name “management 3” (see FIG. 5). The processing content of the third job with the job name “management 3” is “file processing”, and is processing to send the processing result to the next job. The structure condition of the third job registered in the file management table 94C indicates that the third job is file processing, takes the processing result of the second job as input, and outputs the processed files 78A, 78B, 78C from processing each of the input files (FIG. 10). Accordingly, for example, when the job flow information 32 with the job name “customer 1” is specified, the CPU 60 determines at step 120 whether or not the third job included in the job flow information 32 matches the third condition.

An example of determination processing of step 120 is determination as to whether or not plural determination conditions are matched. For example, the determination processing of step 120 illustrated in FIG. 11 may be substituted with determination processing according to each of the condition determinations of steps 120A, 120B, 120C illustrated in FIG. 12. The first condition determination indicates whether or not the third job included in the job flow information 32 is a “job that employs data output from the second job J2” (step 120A illustrated in FIG. 12). The second condition indicates whether or not the third job J3 included in the job flow information 32 is a “job that executes parallel processes in the same application” (the step 120B illustrated in FIG. 12). The third condition indicates whether or not the third job J3 included in the job flow information 32 is a “job to which data output from the second job J2 is input, and that outputs the processing result of the third job J3” (step 120C illustrated in FIG. 12). Affirmative determination of step 120 of FIG. 11 corresponds to when the condition determination of all steps 120A, 120B, and 120C illustrated in FIG. 12 are affirmative determinations. The condition determinations of steps 120A, 120B, and 120C illustrated in FIG. 12 are not limited to the sequence illustrated in FIG. 12. Although a case is illustrated in FIG. 12 in which processing transitions to the condition determination of step 120C after step 122, step 122 and step 120C may be interchanged in sequence.

The cloud distributed execution flag is set to OFF at step 134 when negative determination is made at step 120, and the processing routine is ended. However, when affirmative determination is made at step 120, the CPU 60 sets the executable-in-cloud flag as ON for the third job J3 at step 122, and continues analysis. Namely, in the predetermined structure of the job flow information 32 for increasing processing efficiency of the on-premises system 52, at least a portion of the plural processing processable in parallel (sub-jobs J3-1 to J3-3) of the third job J3 is processable in the cloud system 54. Accordingly, at step 122 the CPU 60 sets the executable-in-cloud flag as ON for the third job J3, and processing proceeds to step 124.

Next, the CPU 60 determines at step 124 whether or not the fourth job matches the fourth condition. The determination at step 124 employs the structure conditions registered in the file management table 94C. Namely, determination is made as to whether or not the fourth included in the job flow information 32 matches the structure condition of the fourth job registered in the file management table 94C. For example, when the job flow name is “customer 1”, the fourth job in the job flow information 32 can be identified as the job with the job name “management 4” from each information of the “comment (processing content)”, “job position”, and “next job position” items (see FIG. 5). The processing content of the fourth job with the job name “management 4” is “file combination (merging)”, and is processing to send the processing result to the next job. The structure condition of the fourth job registered in the file management table 94C indicates that the fourth job is a file combination process, takes the processing result of the third job as input, combines the input files, and outputs the combined file 78 (FIG. 10). The file of the processing result of the third job is the three processed files 78A to 78C. Accordingly, for example, when the job flow information 32 with the job flow name “customer 1” is specified, the CPU 60 determines at step 124 that the fourth job included in the job flow information 32 matches the fourth condition.

An example of determination processing of step 124 is determination as to whether or not plural determination conditions are matched. For example, the determination processing of step 124 illustrated in FIG. 1 may be substituted with determination processing by each of the condition determinations of steps 124A, 124B, and 124C illustrated in FIG. 12. The first condition determination is determination as to whether or not the fourth job J4 is a “job that employs data output from the third job J3” (step 124A illustrated in FIG. 12). The second condition indicates whether or not the fourth job J4 is a “data combination job” (step 124B illustrated in FIG. 12). The third condition indicates whether or not the fourth job J4 is a “job that has data input by the third job J3 as input, and has the processing result of the fourth job J4 as output” (step 124C illustrated in FIG. 12). Affirmative determination at step 124 of FIG. 11 corresponds to when affirmative determination is made as the condition determinations of all of steps 124A, 124B, and 124C illustrated in FIG. 12. Note that the condition determinations of steps 124A, 124B, 124C illustrated in FIG. 12 are not limited to the sequence illustrated in FIG. 12. Moreover, although FIG. 12 illustrates a case in which processing transitions to the condition determination of step 124C after step 126, step 126 and step 124C may be interchanged in sequence.

When negative determination is made at step 124, the cloud distributed execution flag is set as OFF at step 134, and the processing routine is ended. When affirmative determination is made at step 124, the CPU 60 sets the executable-in-cloud flag for the fourth job J4 to OFF at step 126, and continues the analysis. Namely, in the predetermined structure of the job flow information 32 for increasing processing efficiency of the on-premises system 52 (see FIG. 7, and FIG. 10), the fourth job J4 is processed in the on-premises system 52. Accordingly, at step 126 the CPU 60 sets the executable-in-cloud flag for the fourth job J4 to OFF, and processing proceeds to step 128.

Next, the CPU 60 determines at step 128 whether or not the fifth job J5 matches a fifth condition. The determination at step 128 employs the structure conditions registered in the file management table 94C. Namely, determination is made as to whether or not the fifth job included in the job flow information 32 matches the structure condition of the fifth job registered in the file management table 94C. For example, when the job flow name is “customer 1”, the fifth job in the job flow information 32 can be identified as the job with the job name “management 5” from respective information of the “comment (processing content)”, “job position”, and “next job position” items (see FIG. 5). The processing content of the fifth job with the job name “management 5” is “store file in DB”. The structure condition of the fifth job registered in the file management table 94C indicates that the fifth job is storage processing of a file, takes the processing result of the fourth job as input, and stores the input combined file 78 in the RDBMS. Accordingly, for example, when the job flow information 32 with the job flow name “customer 1” is specified, at step 128 the CPU 60 determines whether or not the fifth job included in the job flow information 32 matches the fifth condition.

An example of determination processing of step 128 is determination as to whether or not plural determination conditions are matched. For example, the determination processing of step 128 illustrated in FIG. 11 may be substituted for determination processing according to each of the condition determinations of step 128A and step 128B illustrated in FIG. 12. The first condition determination indicates whether or not the fifth job J5 is “a job that employs data output from the fourth job J4” (step 128A illustrated in FIG. 12). The second condition indicates whether or not the fifth job J5 is a “job that stores data” (the step 128B illustrated in FIG. 12). Affirmative determination of step 128 of FIG. 11 corresponds to when the condition determination of steps 128A and 128B illustrated in FIG. 12 are affirmative determinations. Note that the condition determinations of steps 128A and 128B illustrated in FIG. 12 are not limited to the sequence illustrated in FIG. 12.

When negative determination is made at step 128, the executable-in-cloud flag is set as OFF at step 134, and the processing routine is ended. When affirmative determination is made at step 128, at step 130 the CPU 60 sets the executable-in-cloud flag for the fifth job J5 to OFF, and continues the analysis. Namely, in the predetermined structure of the job flow information 32 for increasing processing efficiency of the on-premises system 52, the fifth job J5 is processed in the on-premises system 52. Accordingly, at step 130 the CPU 60 sets the executable-in-cloud flag for the fifth job J5 to OFF, and processing proceeds to step 132.

Next, at step 132 the CPU 60 sets the cloud distributed execution flag as ON, and the processing routine is ended. Namely, the executable-in-cloud flag is set as ON when the job flow information 32 of the analysis target matches the predetermined structure for increasing processing efficiency of the on-premises system 52 (see FIG. 7, and FIG. 10). The value of the executable-in-cloud flag is registered in the storage section 66 as an analysis result in the registration processing after ending of the processing routine (step 106 of FIG. 9). Namely, each respective value of the “cloud execution assessment flag”, “the job flow change flag”, and the “cloud distributed execution flag” items (see FIG. 4) of the job flow information 32 of the analysis target is registered in the job flow management table 94A. Specifically, “TRUE” is registered as the value of the “cloud execution assessment flag” and the “job flow change flag”, and “TRUE” is registered as the value of the “cloud distributed execution flag”. Registration of the respective value of the “cloud execution assessment flag”, the “job flow change flag”, and the “cloud distributed execution flag” items corresponds to registration of the analysis information 34 in the storage section 66 (FIG. 2). Moreover, this corresponds to registration of the analysis information 34 in the storage section 30 of the internal environment system 12 (FIG. 1).

In the registration processing according to the registration process 84 in the on-premises system 52, the values of the flags set at steps 114, 118, 122, 126, 130 are registered. Namely, the CPU 60 registers “TRUE” or “FALSE” as the value of the executable-in-cloud flag for the target job flow information 32 of the job management table 94B. “TRUE” is registered as the value of the executable-in-cloud flag when the executable-in-cloud flag is set as ON. “FALSE” is registered as the value of the executable-in-cloud flag when the executable-in-cloud flag is set as OFF.

The processing that sets the executable-in-cloud flag as ON (step 122) corresponds to processing that generates analysis information of technology disclosed herein. Namely, the positions of the jobs included in the target job flow information 32 and their executable-in-cloud flags are associated with each other as illustrated in FIG. 5. Accordingly, the processing of step 122 corresponds to a portion of the processing to generate analysis information including the processing sequence in a series of plural jobs for jobs to be processed in parallel by plural execution processing.

Explanation next follows regarding execution processing of the job flow based on the job flow information 32 in the on-premises system 52.

The on-premises system 52 operates as the task scheduler 42A (FIG. 8) by the CPU 60 executing the scheduler function pre-included in the OS 90. The task scheduler 42A corresponds to the job flow specification section 42 (FIG. 1). The on-premises system 52 operates as the job flow execution section 38 (FIG. 1) by the CPU 60 executing the execution process 88.

The task scheduler 42A instructs the execution section 44 to execute the job flow, namely to execute processing of the series of jobs according to the job flow information 32 as a task, execute a specified task at the timing specified by the execution schedule 37. The execution section 44 executes the task specified by the task scheduler 42A using the job flow information 32 of the storage section 66, namely the job flow information 32.

For example, the task scheduler 42A references the execution schedule 37 illustrated by the example of the job flow management table 94A (FIG. 4). The task scheduler 42A detected the current time. The task scheduler 42A determines the job flow information 32 corresponding to the current time in the execution schedule 37 of the job flow management table 94A and instructs the execution section 44 to execute this task, namely the corresponding job flow information 32. Namely, the job flow is executed at a pre-specified time by instructing execution at the “start time” with the “start pattern” for job flow information 32 according to the job flow names for which the “execution flag” is “TRUE” in the job flow management table 94A.

Explanation follows regarding processing according to the execution process 88. The CPU 60 of the on-premises system 52 executes processing based on the job flow information 32 by reading the execution process 88 from the storage section 66, expanding the execution process 88 into the RAM 62, and executing the execution process 88.

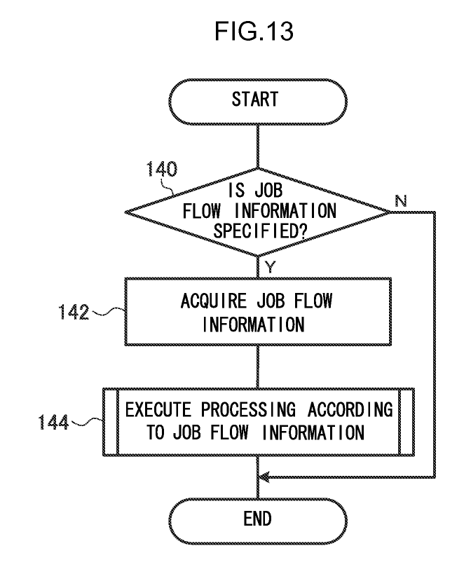

A flow of processing of the execution process 88 is illustrated in FIG. 13. Executing the execution process 88 in the on-premises system 52 caused the on-premises system 52 to operate as the execution section 44 of the data processing device 20 in the internal environment system 12, and to execute processing according to the job flow information 32. The processing routine illustrated in FIG. 13 is repeatedly executed at specified time intervals during operation of the on-premises system 52. Namely, the CPU 60 of the on-premises system 52 executes the processing routine illustrated in FIG. 13 each time the specified time elapses. Note that the processing routine illustrated in FIG. 13 is not limited to being executed repeatedly, and may be configured to execute according to an operating instruction on the input device 63 by the user.

At step 140, the CPU 60 of the on-premises system 52 determines whether or not job flow information 32 is specified. At the time specified by the execution schedule 37, the task scheduler 42A instructs the execution section 44 to execute a specified task, with processing of the job series according to the job flow information 32 as the task. The determination of step 140 is accordingly a determination made by determining whether or not a task has been specified for execution by the task scheduler 42A.

The processing routine is ended when negative determination is made at step 140, since job flow execution is unnecessary. When affirmative determination is made at step 140, the CPU 60 acquires the job flow information 32 at step 142, and, at step 144, executes processing according to the job flow information 32, explained in detail below. Accordingly, job flow information 32 specified by the task scheduler 42A according to the job flow names for which the “execution flag” is TRUE″ in the job flow management table 94A is executed at the “start time” with the “start pattern”.

Further explanation follows regarding execution processing of step 144 illustrated in FIG. 13.

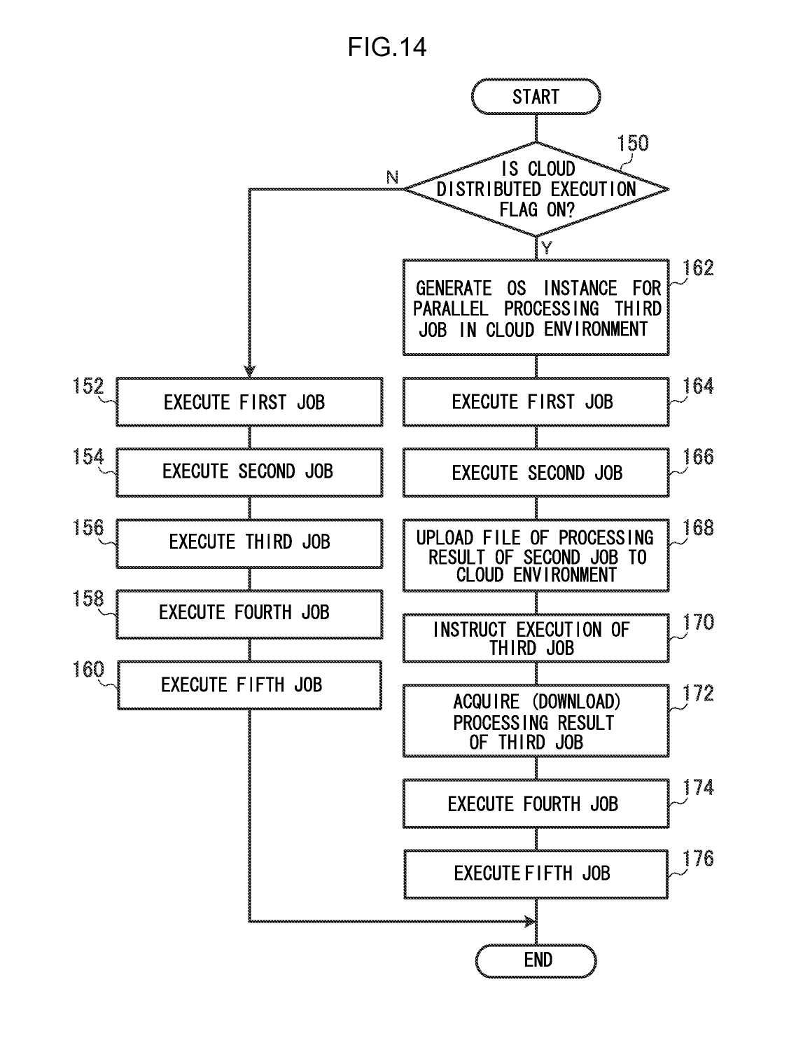

A flow of execution processing according to the job flow information 32 is illustrated in FIG. 14. At step 150 the CPU 60 references the job flow management table 94A, and determines whether or not the cloud distributed execution flag is ON for the execution target job flow information 32. Processing proceeds to step 152 when negative determination is made at step 150, and processing proceeds to step 162 when affirmative determination is made.

When negative determination is made at step 150, the respective jobs are sequentially executed in the on-premises system 52 since all of the processing according to the execution target job flow information 32 is set to be executed in the on-premises system 52. Namely, the CPU 60 first executes the first job J1 (step 152). Next, the CPU 60 sequentially executes the second job J2 (step 154), the third job J3 (step 156), and the fourth job J4 (step 158). The CPU 60 then executes the fifth job J5 (step 160), and the processing routine is ended.

When affirmative determination is made at step 150, since the processing according to the execution target job flow information 32 is set as executable in the cloud system 54, a portion of the processing according to the job flow information 32 is executed in the cloud system 54. When the processing according to the execution target job flow information 32 is executable in the cloud system 54, the structure of the job flow information 32 includes the first job J1, the second job J2, the third job J3, the fourth job J4, and the fifth job J5 (see FIG. 7, and FIG. 10). The first job J1, the second job J2, the fourth job J4, and the fifth job J5 are respectively processed in the on-premises system 52.

The third job J3 includes the plural processing processable in parallel (sub-jobs J3-1 to J3-3), and at least a portion of the processing (sub-jobs J3-1 to J3-3) are processable in the cloud system 54. At step 162, the CPU 60 generates an OS instance on the cloud system 54 in order to execute the third job J3 in the cloud system 54. The processing that generates the OS instance in the cloud system 54 is region generation processing to make the plural processing of the third job J3 (sub-jobs J3-1 to J3-3) processable in parallel. The CPU 60 uploads the execution file to process the plural processing of the third job J3 (sub-jobs J3-1 to J3-3) in parallel to the cloud system 54. An example of the execution file to be uploaded to the cloud system 54 is the program of the specific processing 77 illustrated in FIG. 10.

After executing the first job J1 at the next step 164, similarly to at step 152, the CPU 60 then executes the second job J2 at the next step 166, similarly to at step 154. Next, after uploading the file from the result of executing the second job J2 to the cloud system 54 at step 168, the CPU 60 then, at step 170, instructs the cloud system 54 to execute the third job J3. The cloud system 54 takes the file uploaded at step 168 as input, and executes processing of the third job J3 in parallel using the execution file uploaded at step 162. When execution of the third job J3 has been completed in the cloud system 54, at step 172 the CPU 60 downloads (acquires) a file of processing results processed in parallel in the cloud system 54.

Next, after executing the fourth job J4 at step 174, similarly to at step 158, the CPU 60 executes the fifth job J5 at step 176, similarly to at step 160, and the processing routine is ended.

As explained above, in the first exemplary embodiment the structure of the job flow information 32 indicated by the relationships in the series of plural jobs is analyzed. The determination result is registered as the analysis information 34 associated with the job flow information 32. The analysis information 34 for jobs to be processed in parallel by plural execution processing may include the processing sequence of the series of plural jobs in the job flow information 32, and may specify the position of the jobs indicated by the job flow information 32. Accordingly, employing the analyzed job flow information 32 and the analysis information 34 enables execution in the on-premises system 52 of simple selection of the system in which to process the jobs. For example, jobs executable in the cloud system 54 are identifiable in the on-premises system 52, enabling manual operations by a user in the on-premises system 52 for executing jobs in the cloud system 54 to be suppressed. Causing jobs that were to be executed in the on-premises system 52 to be executed in the cloud system 54 enables distribution of the processing load required for processing in the on-premises system 52, and enables higher speed execution to be realized for the whole system.

Device configuration in the on-premises system 52 generally involves configuration of a permitted processing load of the processing amount of business processing processable using a computer to be predicted by the user who constructed the on-premises system 52. However, the processing amount and processing load of business processing are not necessarily always the values the user predicted. For example, if device configuration in the on-premises system 52 is configuration to permit a maximum value of the processing amount of business processing by the computer operated by the user, a surplus is configured when the maximum value of the processing amount of the business processing is not reached. Moreover, the device configuration in the on-premises system 52 needs to be strengthened when the processing amount of the business processing and the processing load reach their maximum. In the present exemplary embodiment, since automatic selection of the system in which to process jobs is enabled in the on-premises system 52, the processing amount of the business processing and the processing load can be stabilized in the on-premises system 52.

In the first exemplary embodiment, since processing is executed employing the cloud system 54 when executing job processing based on the job flow information 32, the usage ratio of the cloud system 54 can remain at the smallest limit compared to processing that always employs the cloud system 54.

### Second Exemplary Embodiment

Explanation follows regarding a second exemplary embodiment. In the first exemplary embodiment, explanation was given of a case in which respective jobs were associated in the sequence of the first job J1, the second job J2, the third job J3, the fourth job J4, and the fifth job J5, as an example of the structure of the job flow information 32 (see FIG. 7). However, technology disclosed herein is not limited to the structure of the job flow information 32 in which the respective jobs are associated in the sequence of the first job J1 to the fifth job J5. The second exemplary embodiment explains a first modified example of the structure of the job flow information 32. Note that in the second exemplary embodiment, since the configuration is substantially similar to that of the first exemplary embodiment, the same reference numerals are appended to similar parts, and detailed explanation thereof is omitted.

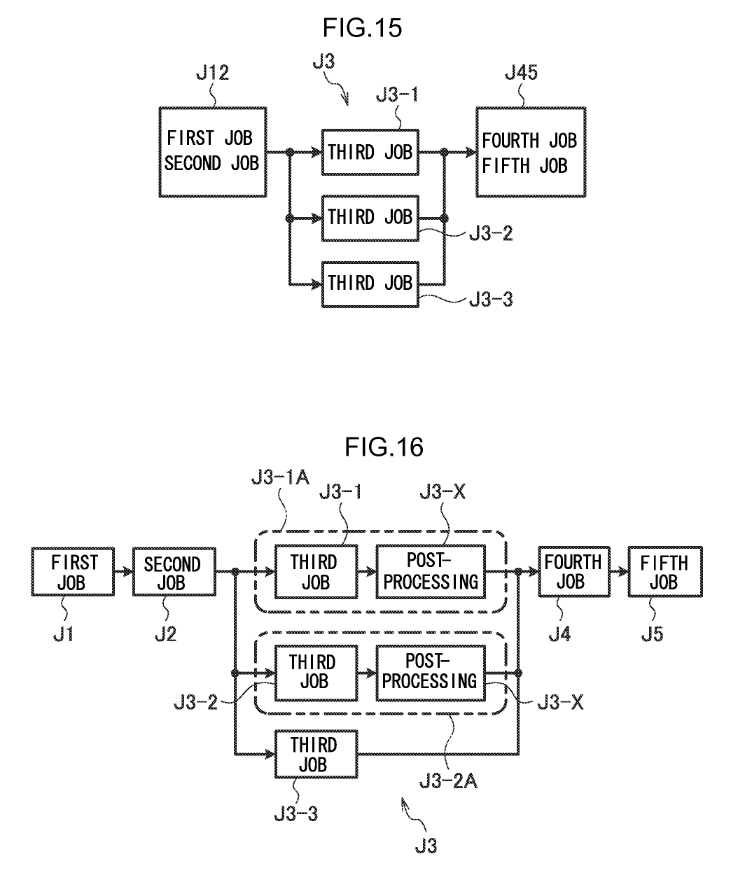

FIG. 15 schematically illustrates a first modified example for a structure according to the proceeding/following relationships between the job positions included in the job flow information 32. In the structure of the job flow information 32 illustrating the first modified example in FIG. 15, respective jobs are associated in the sequence of an acquisition job J12 that is a combination of the first job and the second job, the third job J3, and a storage job J45 that is a combination of the fourth job and the fifth job. Similarly to the first exemplary embodiment, the third job J3 includes the sub-jobs J3-1, J3-2, J3-3 that are matching or substantially similar jobs.

As explained for the first exemplary embodiment, the first job J1 that represents file acquisition processing, and the second job J2 that represents file division processing are processing executed in the on-premises system 52 (see FIG. 7). Accordingly, even when the first job J1 and the second job J2 are configured as a combined single job of the acquisition job J12, the structure is substantially equivalent to the structure of the job flow information 32 illustrated in FIG. 7. The fourth job J4 that represents file combination processing, and the fifth job J5 that represents file storage processing are processing executed in the on-premises system 52 (see FIG. 7). Accordingly, even when the fourth job J4 and the fifth job J5 are configured as a combined single job of the storage job J45, the structure is substantially equivalent to the structure of the job flow information 32 illustrated in FIG. 7.

Accordingly, in the second exemplary embodiment, even when the structure of the job flow information 32 is as illustrated in FIG. 15, similar advantageous effects to those of the first exemplary embodiment can be obtained.

### Third Exemplary Embodiment

Explanation follows regarding a third exemplary embodiment. The third exemplary embodiment is a second modified example for the structure of the job flow information 32. Note that in the third exemplary embodiment, since the configuration is substantially similar to that of the first exemplary embodiment, the same reference numerals are appended to similar parts, and detailed explanation thereof is omitted.

FIG. 16 schematically illustrates a second modified example for a structure according to the proceeding/following relationships between the job positions included in the job flow information 32. In the structure of the job flow information 32 illustrating the second modified example in FIG. 16, the structure of the third job J3 is different from that in the structure of the job flow information 32 illustrated in FIG. 7. Namely, the third job J3 includes the sub-jobs J3-1A, J3-2A, J3-3A similarly to in the first exemplary embodiment. The sub-job J3-1A includes a sub-job J3-1 similar to that of the first exemplary embodiment, and a post-processing J3-X that is input with the processing result of the sub-job J3-1, and outputs the result of performing specific processing. The sub-job J3-2A includes a sub-job J3-2 similar to that of the first exemplary embodiment, and post-processing J3-X that is input with the processing result of the sub-job J3-2 and that outputs the result of performing specific processing.

In the third exemplary embodiment, the configuration of the job flow information 32 is such that the third job J3 takes the processing result of the second job J2 as input, and outputs the processing result of the plural sub-jobs. Namely, the structure of the job flow information 32 processable in parallel is not limited to only including plural identical sub-jobs. Namely, cases are included of the structure of job flow information 32 in which the third job J3 outputs the processing result of the plural sub-jobs.

The condition for the third job J3 in the third exemplary embodiment is similar to the condition in the first exemplary embodiment. Namely, the third job J3 in the third exemplary embodiment corresponds to the structure condition of the third job in the file management table 94C illustrated in FIG. 6. Namely, the third job J3 is input with the respective divided files 76A, 76B, 76C divided by the second job J2, and outputs the respective processed files 78A, 78B, 78C from performing the specific processing 77 on the respective divided files 76A to 76C. The post-processing J3-X of the sub-job J3-1A is input with the processing result from the sub-job J3-1, and outputs the processed file 78A that is the post-processing result. Similarly, the post-processing J3-X of the sub-job J3-2A is input with the processing result of the sub-job J3-2, and outputs the processed file 78B that is the post-processing result.

Accordingly, even in the structure of the third job J3 in the third exemplary embodiment, substantially similar handling to that of the first exemplary embodiment is enabled, and even in the structure of the job flow information 32 illustrated in FIG. 16, similar advantageous effects to those of the first exemplary embodiment can be obtained.

### Fourth Exemplary Embodiment

Explanation follows regarding a fourth exemplary embodiment. In the first exemplary embodiment the analysis processing of the job flow information 32 and the execution processing are separate processing. In the fourth exemplary embodiment the analysis processing, or the execution processing, or both are processing for the processing according to the job flow information 32. Note that in the fourth exemplary embodiment, since the configuration is substantially similar to that of the first exemplary embodiment, the same reference numerals are appended to similar parts, and detailed explanation thereof is omitted.

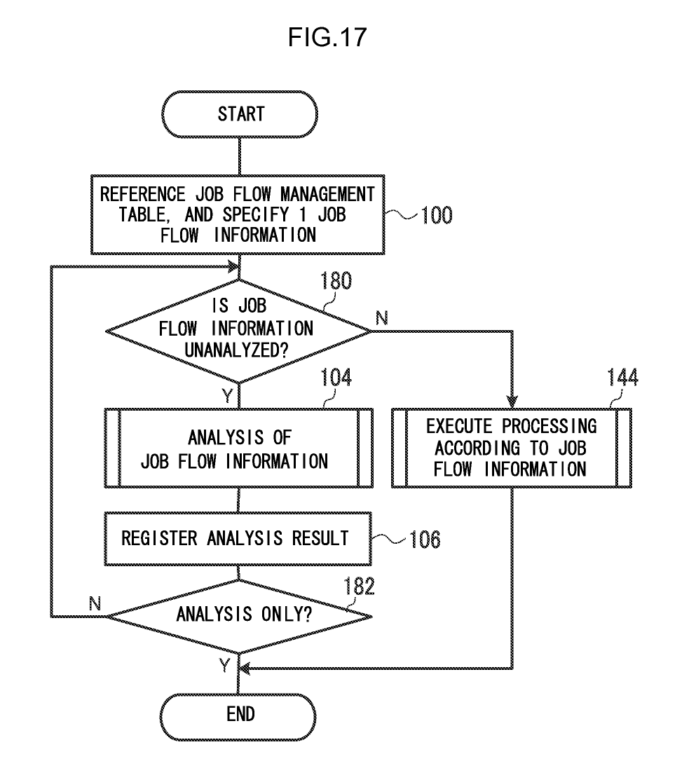

FIG. 17 illustrates a flow of processing that includes the processing of the analysis process 82, the registration process 84, and the execution process 88 that are included in the data processing program 80 executed by the on-premises system 52. Note that the processing routine illustrated in FIG. 17 is repeatedly executed at a specified time interval during operation of the on-premises system 52. Namely, each time the specified time elapses, the CPU 60 of the on-premises system 52 executes the processing routine illustrated in FIG. 17. The processing routine illustrated in FIG. 17 is not limited to repeated execution, and may execute according to an operating instruction of the input device 63 by the user. Although the processing routine illustrated in FIG. 17 illustrates flow for processing of a single job flow information 32, similarly to in the processing routine illustrated in FIG. 9, the job flow information 32 registered in the job flow management table 94A may be sequentially processed.

Similarly to at step 100, in the fourth exemplary embodiment the CPU 60 of the on-premises system 52 references the job flow management table 94A and specifies a single job flow information 32. Next, the CPU 60 determines at step 180 whether or not analysis is incomplete for the specified job flow information 32. Namely, at step 180 the information of the “job flow change flag” item is referenced in the job flow management table 94A for the job flow information 32 specified at step 100, and determination is made as to whether or not analysis in incomplete according to whether or not the value is “FALSE”.

Similarly to at step 144, when negative determination is made at step 180, processing is executed according to the job flow information 32, and the processing routine is ended. However, similarly to at step 104, when affirmative determination is made at step 180, analysis processing of the job flow information 32 is executed, the analysis result is registered (step 106), and the processing proceeds to step 182.

Next, at step 182 the CPU 60 determines whether or not the job flow information 32 specified at step 100 is only for analysis processing of the job flow information 32. Determination as to whether or not it is only for analysis processing of the job flow information 32 may be executed by referencing the job flow management table 94A. For example, the information of the “job flow change flag” item indicates whether or not the analysis result has been completed.

In the fourth exemplary embodiment, the information indicating the “cloud execution assessment flag” item is treated as information indicating whether or not the job flow information 32 is to be executed. Accordingly, analysis and execution is indicated by the value of the “cloud execution assessment flag” item being “TRUE” and the value of the “job flow change flag” item being “FALSE”. Moreover, only execution for the processing according to the job flow information 32 is indicated by the value of the “cloud execution assessment flag” item being “TRUE”, and the value of the “job flow change flag” item being “TRUE”. Only analysis for the processing according to the job flow information 32 is indicated by the value of the “cloud execution assessment flag” item being “FALSE”, and the value of the “job flow change flag” item being “FALSE”. Note the value of the “cloud execution assessment flag” item being “FALSE”, and the value of the “job flow change flag” item being “TRUE” indicates that there is neither analysis nor execution processing. When neither analysis nor execution processing is indicated, specification of the job flow information 32 made at step 100 is removed.

As explained above, in the fourth exemplary embodiment, processing for analysis of the job flow information 32 and for execution of processing according to the job flow information 32 can be performed by the processing routine of FIG. 17, enabling simplification of the system processing.

### Fifth Exemplary Embodiment

Explanation follows regarding a fifth exemplary embodiment. In the first exemplary embodiment the analysis processing and the execution processing of the job flow information 32 are separate processing. In the fifth exemplary embodiment, analysis processing for the job flow information 32, and instruction of execution processing according to the job flow information 32 are executed by a data processing device 20. In the fifth exemplary embodiment, analysis processing on the job flow information 32 and execution processing according to the job flow information 32 is sequentially processed for each job included in the job flow information 32. Note that in the fifth exemplary embodiment, since the configuration is substantially similar to that of the first exemplary embodiment, the same reference numerals are appended to similar parts, and detailed explanation thereof is omitted.

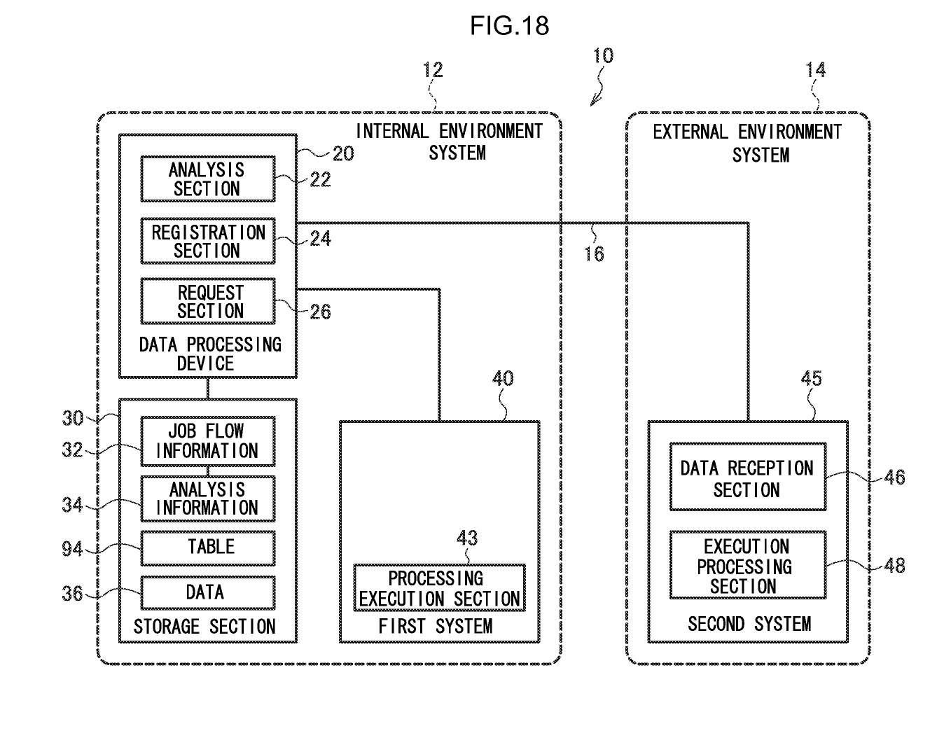

A data processing system 10 according to the fifth exemplary embodiment is illustrated in FIG. 18. The data processing system 10 illustrated in FIG. 18, the data processing device 20 of an internal environment system 12 includes a request section 26. In place of the job flow execution section 38 illustrated in FIG. 1, the internal environment system 12 includes a first system 40 that executes processing according to the job flow information 32. The first system 40 includes a processing execution section 43. The data processing device 20 is connected to the storage section 30 and the first system 40, and the first system 40 is also connected to the storage section 30. In the data processing system 10 illustrated in FIG. 18, the external environment system 14 includes a second system 45 that executes processing according to the job flow information 32. The second system 45 includes the data exchange section 46 and the execution processing section 48 illustrated in FIG. 1. The second system 45 of the external environment system 14 is connected to the data processing device 20 of the internal environment system 12 through the communications line 16.

An example of the data processing system 10 according to the fifth exemplary embodiment is by implementation with the computer system 50 having substantially the same configuration as that illustrated in FIG. 2, and explanation thereof is accordingly omitted.

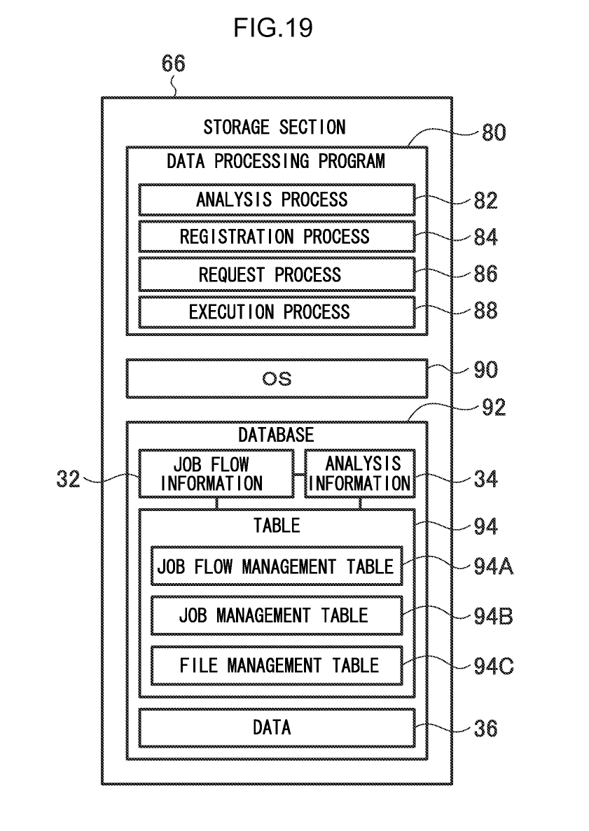

FIG. 19 illustrates an example of information that is stored in the storage section 66 of the on-premises system 52 according to the fifth exemplary embodiment. The storage section 66 of the on-premises system 52 illustrated in FIG. 19 differs in that a request process 86 is included in the data processing program 80 stored in the storage section 66 of the on-premises system 52 illustrated in FIG. 3

The CPU 60 operates as the request section 26 of the data processing device 20 illustrated in FIG. 18 by executing the request process 86. Namely, the on-premises system 52 operates as the request section 26 of the data processing device 20 by the data processing device 20 executing the request process 86 of the data processing program 80 implemented by the on-premises system 52. The CPU 60 operates as the processing execution section 43 in the first system 40 included in the internal environment system 12 illustrated in FIG. 18 by executing the execution process 88. Namely, the on-premises system 52 operates as the processing execution section 43 of the first system 40 in the internal environment system 12 by the internal environment system 12 executing the execution process 88 implemented by the on-premises system 52.

Explanation follows regarding the processing of the data processing device 20 according to the fifth exemplary embodiment. Processing related to the job flow information 32 is executed by the CPU 60 of the on-premises system 52 reading the data processing program 80 from the storage section 66, expanding the data processing program 80 into the RAM 62, and executing the data processing program 80.

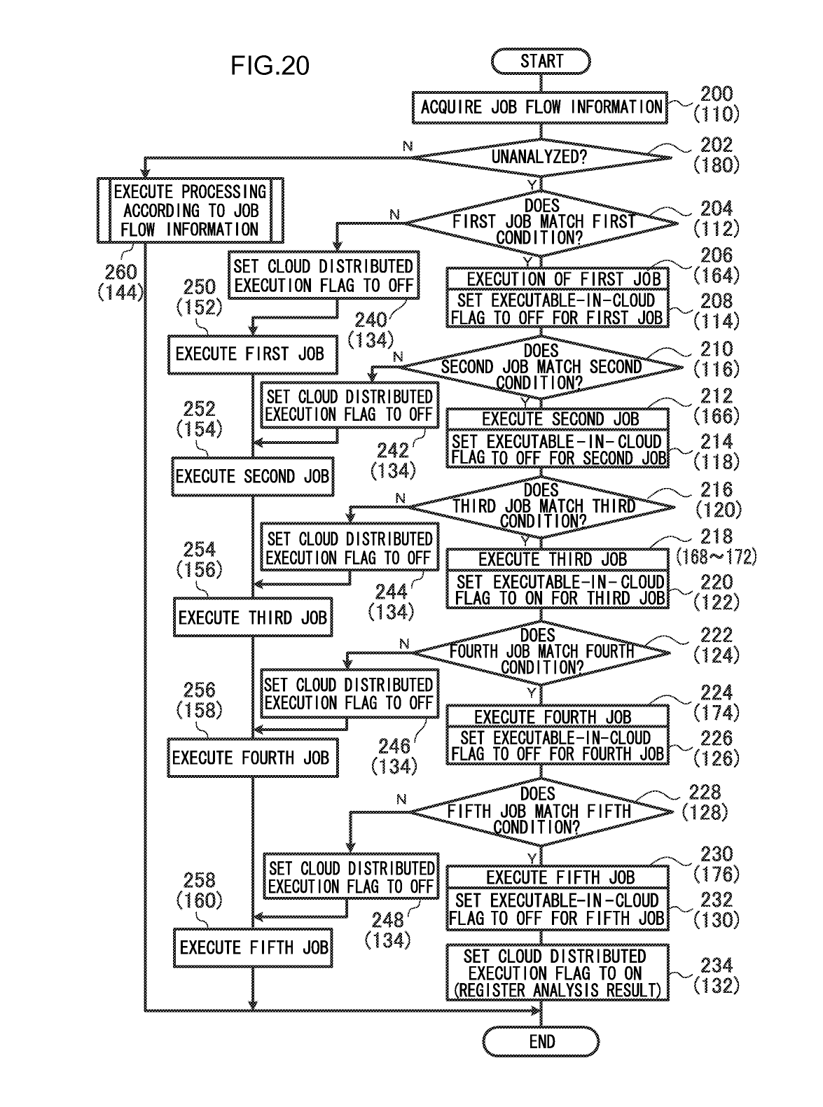

FIG. 20 illustrates an example of a flow of processing of the data processing program 80. The CPU 60 of the on-premises system 52 acquires the job flow information 32 at step 200. The processing of step 200 is processing similar to the processing of step 110 illustrated in FIG. 11. The specified job flow information 32 from the job flow management table 94A may be employed at step 200. Namely, the job flow information 32 specified similarly to at step 100 illustrated in FIG. 9 may be employed.

At the next step 202, the CPU 60 determines whether or not the job flow information 32 acquired at step 200 is unanalyzed. The determination processing of step 202 is similar to the determination processing of step 180 illustrated in FIG. 17. When negative determination is made at step 202, at step 260 the CPU 60 executes processing according to the job flow information 32 similarly to in the processing of step 144 illustrated in FIG. 17, and the processing routine is ended. However, when affirmative determination is made at step 202, at the next step 204 the CPU 60 determines whether or not the first job J1 included in the job flow information 32 matches the first condition. The determination processing of step 204 is similar to the determination processing of step 112 illustrated in FIG. 11.

When affirmative determination is made at determination processing of step 204 the CPU 60 proceeds to processing of step 206. At step 206, in order to execute the processing of the first job J1 in the on-premises system 52, the CPU 60 requests the processing execution section 43 of the first system 40 to execute the first job J1. Execution of the first job J1 by the processing execution section 43 of the first system 40 by requesting execution of the first job J1 at step 206 is similar to processing of step 164 illustrated in FIG. 14. Next, at step 208 the CPU 60 sets the executable-in-cloud flag to OFF for the first job J1, and proceeds to step 210. The processing of step 208 is similar to the processing of step 114 illustrated in FIG. 11.

However, when negative determination is made at step 204, the CPU 60 proceeds to step 240 and sets the cloud distributed execution flag to OFF. At the next step 250, the CPU 60 requests execution of the first job J1 and processing proceeds to step 252. The processing of step 240 is similar to the processing of step 134 illustrated in FIG. 11. Moreover, the processing of step 250 is similar to the processing of step 152 illustrated in FIG. 14.

Next, at step 210 the CPU 60 determines whether or not the second job J2 matches the second condition. The determination processing of step 210 is similar to the determination processing of step 116 illustrated in FIG. 11. When affirmative determination is made at step 210, at step 212 the CPU 60 makes a request for execution of the second job J2 to the processing execution section 43 of the first system 40, and at the next step 214, sets the executable-in-cloud flag to OFF for the second job J2, and processing proceeds to step 216. At step 212, execution of the second job J2 by the processing execution section 43 of the first system 40 by requesting execution of the second job J2 is similar to processing of step 166 illustrated in FIG. 14. Moreover, the processing of step 214 is similar to the processing of step 118 illustrated in FIG. 11.

However, when negative determination is made at step 210, the CPU 60 proceeds to step 242 and sets the cloud distributed execution flag to OFF, and at the next step 252, requests execution of the second job J2 and proceeds to step 254. The processing of step 242 is similar to the processing of step 134 illustrated in FIG. 11. The processing of step 252 is similar to the processing of step 154 illustrated in FIG. 14.

Next, at step 216 the CPU 60 determines whether or not the third job J3 matches the third condition. The determination processing of step 216 is similar to the determination processing of step 120 illustrated in FIG. 11. When affirmative determination is made at determination processing of step 216, at step 218 the CPU 60 makes a request for execution of the third job J3 to the second system 45 in the cloud system 54. Next, at step 220 the CPU 60 sets the executable-in-cloud flag to ON for the third job J3 and processing proceeds to step 222. At step 218, processing causes the second system 45 to execute the third job J3 by requesting execution of the third job J3 is similar to processing of steps 162, and 168 to 172 illustrated in FIG. 14. Moreover, the processing of step 220 is similar to the processing of step 122 illustrated in FIG. 11.

When negative determination is made at step 216 the processing proceeds to step 244 and the CPU 60 sets the executable-in-cloud flag to OFF. At the next step 245, the CPU 60 requests execution of the third job J3 and then processing proceeds to step 256. The processing of step 244 is similar to the processing of step 134 illustrated in FIG. 11. The processing of step 254 is similar to the processing of step 156 illustrated in FIG. 14.

Next, at step 222 the CPU 60 determines whether or not the fourth job J4 matches the fourth condition. The determination processing of step 222 is similar to the determination processing of step 124 illustrated in FIG. 11. When affirmative determination is made at step 222, at step 224 the CPU 60 makes a request for execution of the fourth job J4 to the processing execution section 43 of the first system 40. At the next step 226, the CPU 60 sets the executable-in-cloud flag to OFF for the fourth job J4 and processing proceeds to step 228. At step 224, executing the fourth job J4 by requesting the processing execution section 43 of the first system 40 to execute of the fourth job J4 is similar to processing of step 158 illustrated in FIG. 14. Moreover, the processing of step 226 is similar to the processing of step 126 illustrated in FIG. 11.

However, when negative determination is made a step 222, processing proceeds to step 246 and the CPU 60 sets the cloud distributed execution flag to OFF. At the next step 256, the CPU 60 requests execution of the fourth job J4 and processing proceeds to step 258. The processing of step 246 is similar to the processing of step 134 illustrated in FIG. 11. The processing of step 256 is similar to the processing of step 158 illustrated in FIG. 14.

Next, at step 228 the CPU 60 determines whether or not the fifth job J5 matches the fifth condition. The determination processing of step 228 is similar to the determination processing of step 128 illustrated in FIG. 11. When affirmative determination is made at step 228, at step 230 the CPU 60 requests execution of the fifth job J5 to the processing execution section 43 of the first system 40. At the next step 232, the CPU 60 sets the executable-in-cloud flag for the fifth job J5 to OFF and processing proceeds to step 234. At step 234, similarly to the processing of step 132 illustrated in FIG. 11, the cloud distributed execution flag is set to ON and the processing routine is ended. At step 230 the processing execution section 43 of the first system 40 executing the fifth job J5 by requesting execution of the fifth job J5 is similar to the processing of step 160 illustrated in FIG. 14. The processing of step 232 is similar to the processing of step 130 illustrated in FIG. 11.

However, when negative determination is made at step 228, the CPU 60 proceeds to step 248 and sets the cloud distributed execution flag to OFF. At the next step 285, the CPU 60 requests execution of the fifth job J5 and the processing routine is ended. The processing of step 248 is similar to the processing of step 134 illustrated in FIG. 11. The processing of step 258 is similar to the processing of step 160 illustrated in FIG. 14.

As explained above, in the fifth exemplary embodiment, structure analysis of the job flow information 32, and execution of the jobs included in job flow information 32 are achieved by sequential processing. This accordingly enables the structure analysis of the job flow information 32 and execution of the jobs included in the job flow information 32 to be performed all together, namely in collaboration. Enabling processing to be performed all together for the structure analysis of the job flow information 32 and execution of the jobs included in the job flow information 32 enables the flow of processing to be simplified compared with separate processing of analysis processing and execution processing,

### Sixth Exemplary Embodiment

The first exemplary embodiment aims to increase processing efficiency of the data processing system 10 by processing jobs processable in parallel in the external environment system 14 while performing processing of the respective plural jobs indicated by the job flow information 32. The sixth exemplary embodiment aims to achieve efficient coexistence of the internal environment system 12 and the external environment system 14 for the jobs processable in parallel, and to increase the processing efficiency of the data processing system 10. Note that in the sixth exemplary embodiment, since the configuration is substantially similar to that of the first exemplary embodiment, the same reference numerals are appended to similar parts, and detailed explanation thereof is omitted.

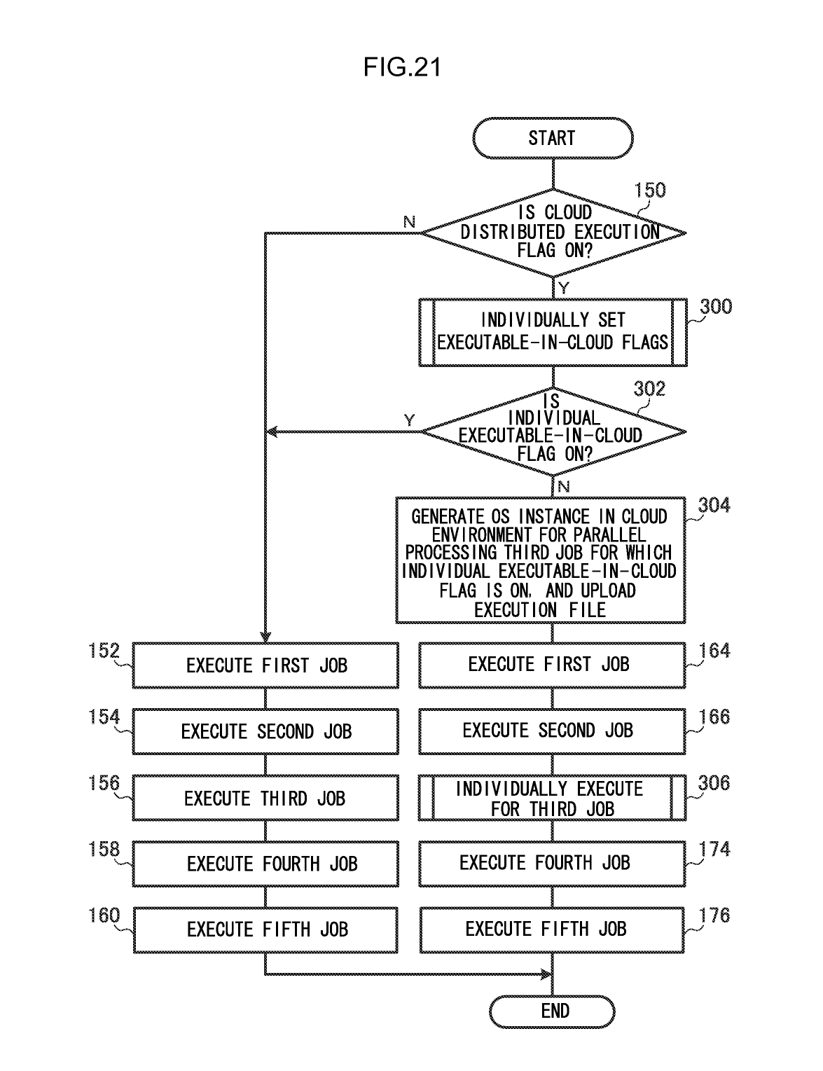

FIG. 21 illustrates a flow of execution processing according to the job flow information 32 in the sixth exemplary embodiment. Note that the flow of the execution processing of the job flow information 32 illustrated in FIG. 21 is substantially similar to the flow of the execution processing according to the job flow information 32 illustrated in FIG. 14. The points of difference between FIG. 21 and FIG. 14 is that the processing of step 162 illustrated in FIG. 14 is changed to the processing of steps 300, 302, and 304 illustrated in FIG. 21, and that the processing of steps 168, 170, and 172 illustrated in FIG. 14 has been changed to the processing of step 306 illustrated in FIG. 21.

When execution processing is started according to the job flow information 32 illustrated in FIG. 21, the CPU 60 references the job flow management table 94A, and determines whether or not the cloud distributed execution flag is ON for the execution target job flow information 32 (step 150). Negative determination is made at step 150 when the processing according to the execution target job flow information 32 is all set to be executed in the on-premises system 52, and the respective jobs are sequentially executed (steps 152 to 160).

However, since processing according to the execution target job flow information 32 is executable in the cloud system 54 when negative determination is made at step 150, the job is set to be executed in the cloud system 54. Namely, at step 300 the CPU 60 individually sets the executable-in-cloud flags indicating that execution is to be performed in the cloud system 54 for the respective plural processing processable in parallel included in the third job J3 (the sub-jobs J3-1 to J3-3) (more detailed description follows). Next, at step 302 the CPU 60 determines whether or not all of the individual executable-in-cloud flags are set to OFF. Affirmative determination is made at step 302 when all of the individual executable in the cloud flags are set to OFF, and processing transitions to step 152 and the respective jobs are sequentially executed since processing according to the execution target job flow information 32 is all set to be executed in the on-premises system 52.

When negative determination is made at step 302, at step 304 the CPU 60 generates the OS instance in the cloud system 54 in order to execute at least a portion of the third job J3 in the cloud system 54.

Next, the CPU 60 executes the first job J1 (step 164), and executes the second job J2 (step 166). Next, at step 306 the CPU 60 individually executes the plural processing processable in parallel included in the third job J3 (the sub-jobs J3-1 to J3-3) based on the individual executable-in-cloud flags set at step 300 (described in more detail below). Next, the CPU 60 executes the fourth job J4 (step 174), executes the fifth job J5 (step 176), and ends the processing routine.

More detailed explanation follows regarding the individual setting processing at step 300 illustrated in FIG. 21. In the sixth exemplary embodiment, according to the operating conditions of the on-premises system 52, namely, when there is available processing capacity in the on-premises system 52, the plural processing processable in parallel included in the third job J3 are allotted to the on-premises system 52.

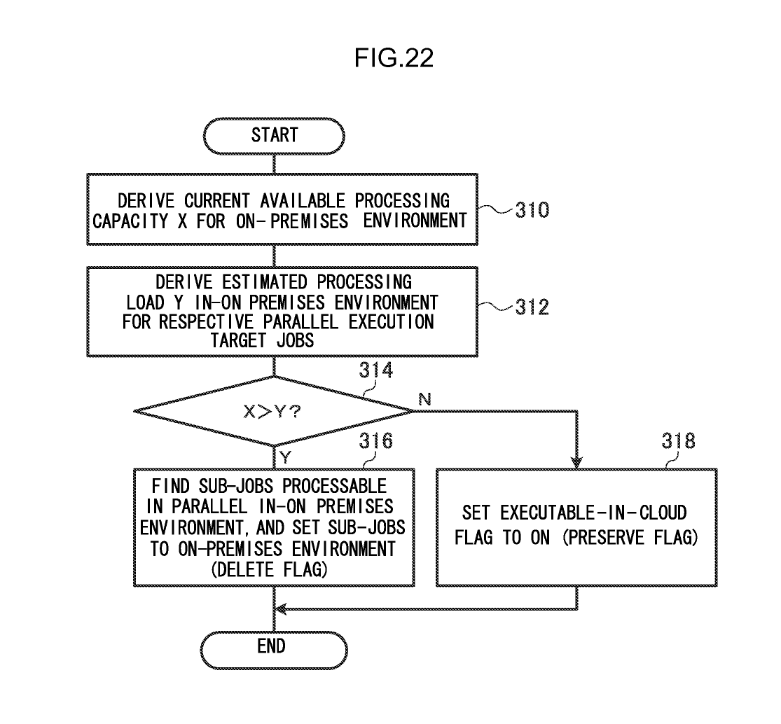

FIG. 22 illustrates an example of a flow of the setting processing of the individual executable-in-cloud flags of step 300. When allotment to the on-premises system 52 is possible, step 300 executes processing that sets the individual executable-in-cloud flags to ON for a portion of the third job J3.

At step 310 the CPU 60 detects the current operating conditions of the on-premises system 52, and derives a processing surplus X of the on-premises system 52 from the detection result. An example of the detection of the current operating conditions of the on-premises system 52 is detection of the CPU load or the CPU usage ratio in the on-premises system 52. Another example is the usage ratio of a system resource. The available processing capacity X is a spare portion of the device configuration in the on-premises system 52 available for job processing, namely currently unused device configuration, and an unused fraction of CPU are examples thereof.

Then at step 312, the CPU 60 derives a predicted processing load Y for the respective jobs that are parallel processing execution targets in the on-premises system 52. The predicted processing load Y may be detected by causing the jobs that are parallel processing execution targets to actually operate on the on-premises system 52, or may be derived on the basis of previous processing loads, stored in the storage section 66, and acquired therefrom. The third job J3 includes plural jobs (the sub-jobs J3-1 to J3-3) processable in parallel (see FIG. 7, and FIG. 10). The predicted processing load Y is accordingly derived for each of the sub-jobs J3-1 to J3-3.

Next, at step 314 the CPU 60 determines whether or not the available processing capacity X exceeds the predicted processing load Y (X>Y). When negative determination is made at step 314, the third job J3 is to be executed on the cloud system 54 and the individual executable-in-cloud flags are all set to ON (step 318) since there is no surplus in the on-premises system 52 for processing the jobs of the parallel processing execution targets.

However, when affirmative determination is made at step 314, since there is available capacity in the on-premises system 52 for processing the jobs that are parallel processing execution targets, sub-jobs J3-1 to J-3 executable in the cloud system 54 are sought in the third job J3 in the range of the available processing capacity X. At step 316 the individual executable-in-cloud flags are set to OFF for the found sub-jobs J3-1 to J3-3 executable in the cloud system 54 (step 316). For example, when the predicted processing loads of the respective sub-jobs J3-1 to J3-3 are substantially similar to each other and the predicted processing load of one sub-job is within the range of the available processing capacity X, the individual executable-in-cloud flag is set to OFF for one of the sub-jobs out of the sub-jobs J3-1 to J3-3. When the predicted processing load of the entire third job J3 is within the range of the available processing capacity X, the individual executable-in-cloud flags are set to OFF for all of the sub-jobs J3-1 to J3-3.

More detailed explanation follows regarding individual execution processing of the third job J3 of step 306 illustrated in FIG. 21. In the sixth exemplary embodiment, the plural processing included in the third job J3 that are processable in parallel are allotted to the on-premises system 52 according to the operating conditions of the on-premises system 52, namely when there is available processing capacity in the on-premises system 52. As described above, a portion or all of the sub-jobs that are parallel processing execution targets out of the third job J3 are set as executable in the on-premises system 52 according to the current operating conditions of the on-premises system 52.

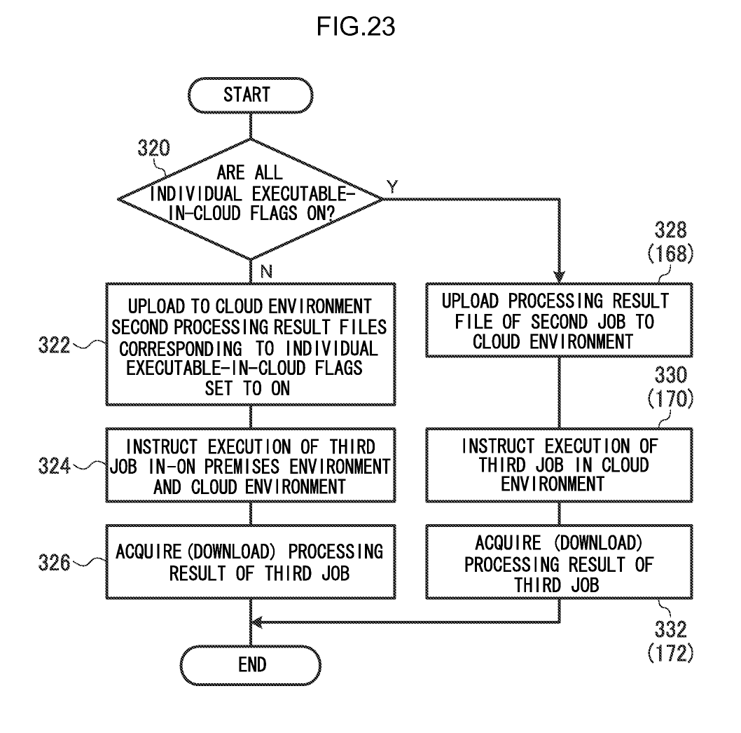

FIG. 23 illustrates an example of a flow of individual execution processing of the third job J3 of step 306. In the processing of step 306, the plural processing included in the third job J3 that are parallel processable are individually executed based on the individual executable-in-cloud flags.

At step 320 the CPU 60 determines whether or not the third job J3 is to be executed in the cloud system 54 by determining whether or not the individual executable-in-cloud flags are all set to ON. When affirmative determination is made at step 320, similarly to at step 168 illustrated in FIG. 14, at step 328 the CPU 60 uploads the file of the result of executing the second job J2 to the cloud system 54. Next, similarly to at step 170 illustrated in FIG. 14, at step 330 execution of the third job J3 is instructed to the cloud system 54. Parallel processing of the third job J3 is executed in the cloud system 54. Next, similarly to at step 172 illustrated in FIG. 14, at step 332 the CPU 60 downloads (acquires) the file of the processing result processed in parallel in the cloud system 54.

However, when negative determination is made at step 320, at step 322 the CPU 60 uploads the files of the result of executing the second job J2 to the cloud system 54. The files corresponding to the plural sub-jobs of the third job J3 with individual executable-in-cloud flags set to ON are uploaded to the cloud system 54. Namely, the inputs for the sub-jobs of the third job J3 are transmitted to the cloud system 54 in order to execute at least a portion of the third job J3.

Next, a step 324 the CPU 60 instructs execution of the third job J3 to the on-premises system 52, or the cloud system 54, or both. The execution instruction for the third job J3 changes according to the setting of the individual executable-in-cloud flags. Namely, execution of the third job J3 is instructed to the cloud system 54 when at least one of the individual executable-in-cloud flags is set to ON. Execution of the third job J3 is instructed to the on-premises system 52 when at least one of the individual executable-in-cloud flags is set to OFF. When execution of the third job J3 is instructed to the cloud system 54, the file uploaded in the above step 322 is input, and processing of the third job J3 is executed in the cloud system 54 using the execution files uploaded at the above step 304. When execution of the third job J3 is instructed to the on-premises system 52, in the on-premises system 52 the processing of the third job J3 is executed corresponding to the jobs for which the individual executable-in-cloud flags are set to OFF, using the execution result of the second job J2 according to the above step 166. The third job J3 is accordingly processed in parallel by the on-premises system 52 and the cloud system 54.

When execution of the third job J3 is completed in the cloud system 54, at step 326 the CPU 60 downloads (acquires) the file of the processing result processed by the cloud system 54.

Device configuration in the on-premises system 52 generally involves configuration of a permitted processing load of the processing amount of business processing processable using a computer to be predicted by the user who constructed the on-premises system 52. However, the processing amount and processing load of business processing are not necessarily always the values the user predicted. For example, if device configuration in the on-premises system 52 is configuration to permit a maximum value of the processing amount of business processing by the computer operated by the user, a surplus is configured when the maximum value of the processing amount of the business processing is not reached. Moreover, the device configuration in the on-premises system 52 needs to be strengthened when the processing amount of the business processing and the processing load reach their maximum. In the present exemplary embodiment, since automatic selection of the system in which to process jobs is enabled in the on-premises system 52, the processing amount of the business processing and the processing load can be stabilized in the on-premises system 52.

As explained above, in the sixth exemplary embodiment, when there is, from the analysis result of the job flow information 32, a job to be processed in parallel executed in the cloud system 54, a portion or all thereof can be processed by the on-premises system 52, depending on the operating conditions of the on-premises system 52. Accordingly, maximum usage of resources based on the configuration of the on-premises system 52 is enabled.

In the sixth exemplary embodiment, when executing the processing of the jobs based on the job flow information 32, since processing is executed employing the cloud system 54, the usage ratio of the cloud system 54 can be kept to a minimum compared to when processing always employs the cloud system 54.

Moreover, distributed execution of business processing based on the job flow information 32 is enabled according to both systems of the on-premises system 52 and the cloud system 54, enabling an increase in processing efficiency of the data processing system 10.

Although explanation in the sixth exemplary embodiment has been given of a case in which the data processing system 10 includes the internal environment system 12 and the external environment system 14, the external environment system 14 is not strictly necessary. For example, the data processing system 10 is also applicable when the data processing system 10 includes the internal environment system 12, but does not include the external environment system 14. Namely, when the present exemplary embodiment is applied as described above in cases when the internal environment system 12 has sufficient available capacity, requests for parallel processing to the external environment system 14 are unnecessary. In cases in which plural independent systems are provided in the internal environment system 12, any one of the systems may act as the internal environment system of the present exemplary embodiment, and another system may be substituted as the external environment system 14. Moreover, in cases in which the internal environment system 12 is provided with plural independent systems, each of the above exemplary embodiments is applicable by applying any one of the systems act as the internal environment system and substituting another system as the external environment system 14.

Note explanation has been given in which the data processing system 10 is implemented by the computer system 50. However, there is no limitation to such a configuration, and obviously various improvements and modifications may be implemented within a range not departing from the spirit as explained above.

Although explanation has been given above of a mode in which a program is pre-stored (installed) in a storage section, there is no limitation thereto. For example, the data processing programs of the technology disclosed herein may be provided in a format recorded on a recording medium, such as a CD-ROM or a DVD-ROM.

An aspect enables an increase in processing efficiency of a processing device that processes jobs based on job flow information.

All publications, patent applications and technical standards mentioned in the present specification are incorporated by reference in the present specification to the same extent as if the individual publication, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the technology disclosed herein have been described in detail, it should be understood that the various changes, substitutions, and alterations could be made hereto without departing from the spirit and scope of the invention.

What is claimed is:

1. A data processing device comprising:
a memory configured to store job flow information that includes a processing sequence information indicating a processing sequence of a plurality of jobs and a processing content information indicating respective processing content of the plurality of jobs; and
a processor configured to execute a process, the process comprising:
generating an analysis information including parallel processing information and parallel processing sequence information by analyzing the job flow information based on the processing sequence information and the processing content information, the parallel processing information indicating jobs processable in parallel, and the parallel processing sequence information indicating a processing sequence of the jobs processable in parallel; and
associating the analysis information with corresponding part of the job flow information and storing the associated information in the memory.

2. The data processing device of claim 1, wherein
in the analysis of the job flow information, a job that appears in the processing sequence next after a job to perform division processing by dividing input data and outputting a plurality of data, that is also a job including processing content to perform specific processing respectively on a plurality of input data, is designated as the job processable in parallel.

3. The data processing device of claim 1, wherein
in the analysis of the job flow information, a job that appears in the processing sequence before a job to perform combination processing by combining a plurality of input data and outputting combined data, that is also a job including processing content to perform specific processing respectively on a plurality of input data, is designated as the job processable in parallel.

4. The data processing device of claim 1, the process further comprising:
reading the job flow information stored in the memory, and the analysis information registered in association with the job flow information; and
respectively processing the plurality of jobs according to the processing sequence, and processing a processing target job in an external environment system capable of parallel processing when the processing target job is the job processable in parallel.

5. The data processing device of claim 4, wherein, when the processing of the processing target job is caused to be processed in the external environment system capable of parallel processing:
an available processing capacity is detected for processing load in the device itself;
processing loads for respectively performing specific processing on the plurality of data are derived for the jobs processable in parallel; and
the specific processing is processed on a plurality of respective data having a processing load processable within the available processing capacity, and other specific processing that would result in the processing load exceeding the available processing is caused to be processed in the external environment system.

6. The data processing device of claim 1, wherein the process comprises
when analyzing the job flow information of an analysis target according to the processing sequence of the plurality of respective jobs, requesting processing of jobs for which analysis has been completed in the plurality of respective jobs, and, when the processing target job is the job processable in parallel, requesting the external environment system capable of parallel processing to process the processing target job.

7. The data processing device of claim 6, wherein
when the processing of the processing target job is caused to be processed in the external environment system capable of parallel processing:
an available processing capacity is detected for processing load in the device itself;
processing loads for respectively performing specific processing on the plurality of data are derived for the jobs processable in parallel; and
the specific processing is processed on a plurality of respective data having a processing load processable within the available processing capacity, and other specific processing that would result in the processing load exceeding the available processing is requested to the external environment system.

8. A data processing method comprising:
by a processor, taking job flow information that is stored in a memory and includes information indicating a processing sequence for a plurality of jobs and information indicating respective processing content of the plurality of jobs, analyzing the job flow information based on the information indicating the processing sequence and the information indicating the processing content, and generating analysis information including information indicating jobs processable in parallel and information indicating a processing sequence of the jobs processable in parallel; and
associating the job flow information that was a target of analysis with the analysis information obtained from the job flow information that was the target of analysis and registering the associated information in the memory.

9. The data processing method of claim 8, wherein
in the analysis of the job flow information, a job that appears in the processing sequence next after a job to perform division processing by dividing input data and outputting a plurality of data, that is also a job including processing content to perform specific processing respectively on a plurality of input data, is designated as the job processable in parallel.

10. The data processing method of claim 8, wherein
in the analysis of the job flow information, a job that appears in the processing sequence before a job to perform combination processing by combining a plurality of input data and outputting combined data, that is also a job including processing content to perform specific processing respectively on a plurality of input data, is designated as the job processable in parallel.

11. The data processing method of claim 8, further comprising:
reading the job flow information stored in the memory, and the analysis information registered in association with the job flow information; and
respectively processing the plurality of jobs according to the processing sequence, and processing a processing target job in an external environment system capable of parallel processing when the processing target job is the job processable in parallel.

12. The data processing method of claim 8, wherein, when analyzing the job flow information of an analysis target according to the processing sequence of the plurality of respective jobs in the analysis of the job information, processing of respective jobs out of the plurality of jobs is requested when the respective analysis has been completed for the plurality of respective jobs, and, when the processing target job is the job processable in parallel, the processing of the processing target job is caused to be processed in an external environment system capable of parallel processing.

13. The data processing method of claim 11, wherein
when the processing of the processing target job is caused to be processed in the external environment system capable of parallel processing:
an available processing capacity is detected for processing load in the processor itself;
processing loads for respectively performing specific processing on the plurality of data is derived for the jobs processable in parallel; and
the specific processing is processed on the plurality of respective data having a processing load processable within the available processing capacity, and other specific processing that would result in the processing load exceeding the available processing is caused to be processed in the external environment system.

14. A non-transitory computer-readable recording medium storing therein a data processing program that causes a computer to execute a process, the process comprising:
taking job flow information that is stored in a memory and includes information indicating a processing sequence for a plurality of jobs and information indicating respective processing content of the plurality of jobs, analyzing the job flow information based on the information indicating the processing sequence and the information indicating the processing content, and generating analysis information including information indicating jobs processable in parallel and information indicating a processing sequence of the jobs processable in parallel; and
associating the job flow information that was a target of analysis with the analysis information obtained from the job flow information that was the target of analysis and registering the associated information in the memory.
